(19) United States
(12) Patent Application Publication
(10) Pub. No.: US 2024/0116817 A1
(43) Pub. Date: Apr. 11, 2024

(54) CERAMIC MONOLITH COMPOSITION

(71) Applicant: EXXONMOBIL TECHNOLOGY AND ENGINEERING COMPANY, Annandale, NJ (US)

(72) Inventors: Changmin Chun, Raritan, NJ (US); Wesley SATTLER, Parsippany, NJ (US); Anjaneya S. KOVVALI, Herndon, VA (US)

(21) Appl. No.: 18/481,377

(22) Filed: Oct. 5, 2023

Related U.S. Application Data
(60) Provisional application No. 63/378,743, filed on Oct. 7, 2022.

(51) Int. Cl. C04B 35/10; B01J 23/755; B01J 35/04; C01B 3/26; C01B 3/38; C01B 3/40; C04B 38/00

(52) U.S. Cl. CPC C04B 35/10; B01J 23/755; B01J 35/04; C01B 3/26; C01B 3/382; C01B 3/40; C04B 38/0006; C04B 38/0051; C04B 38/0067; C01B 2203/1082; C01B 2203/1604; C01B 2203/1614; C04B 2235/3217; C04B 2235/3418

(57) ABSTRACT

Ceramic monolith compositions are provided with improved stability under reaction conditions involving elevated temperatures. Such monoliths can be used, for example, in reverse flow reactors under high temperature reforming conditions, where the interior components of the reaction zone can be exposed to average temperatures of 1000° C. or higher while also being exposed to rapid oscillations in temperature of 100° C. or more in the presence of alternating oxidizing and reducing chemistries. The ceramic monolith compositions can be composed of materials that have improved ability to withstand conditions in severe reaction environments. Additionally or alternately, the ceramic monolith compositions can have structural features that reduce or minimize the tendency for the monolith to suffer structural failure under the conditions in severe reaction environments.

### CROSS REFERENCE TO RELATED APPLICATION

This non-provisional patent application claims priority to U.S. provisional patent app. No. 63/378,743, filed Oct. 7, 2022, and titled “CERAMIC MONOLITH COMPOSITION,” the entire contents of which is incorporated herein by reference.

### FIELD OF THE INVENTION

This invention relates to ceramic monolith compositions suitable for use in hydrocarbon reforming in high temperature environments, along with methods for using such monoliths for hydrogen production.

### BACKGROUND OF THE INVENTION

Reverse flow reactors are an example of a reactor type that is beneficial for use in processes with cyclic reaction conditions. For example, due to the endothermic nature of reforming reactions, additional heat needs to be introduced on a consistent basis into the reforming reaction environment. Reverse flow reactors can provide an efficient way to introduce heat into the reaction environment. After a portion of the reaction cycle used for reforming or another endothermic reaction, a second portion of the reaction cycle can be used for combustion or another exothermic reaction to add heat to the reaction environment in preparation for the next reforming step. U.S. Pat. Nos. 7,815,873 and 8,754,276 provide examples of using reverse flow reactors to perform various endothermic processes in a cyclic reaction environment.

Endothermic reactions such as reforming can also benefit from having a substantial amount of available catalytic surface area. Ceramic monolith structures are an example of a type of structure that can provide a high available surface area. One option can be to use a monolith corresponding to a packed array of cells or channels that the reactant gases pass through. Washcoats are added to such monoliths to provide catalytic activity.

Due in part to the ability to perform direct heating of the interior surfaces of a reverse flow reactor while maintaining high purity in the resulting hydrogen product, reverse flow reactors have the potential to provide substantial advantages over conventional steam reforming configurations. However, some practical challenges remain. For example, one of the difficulties with using a reverse flow reactor for reforming is that the reaction environment is cycled rapidly at elevated temperatures. Portions of the reaction environment can experience swings of 100° C. or more relative to a baseline temperature of roughly 1000° C. Under these conditions, conventional monolith structures can rapidly break down, resulting in substantial loss of catalytic activity and thus requiring system maintenance shut downs at undesirably frequent intervals. What is needed are monolith compositions and structures that have sufficient mechanical integrity to allow for extended run length operation of a reverse flow reactor for hydrogen production.

U.S. Patent Application Publication 2020/0030778 describes monolith structures for use in hydrocarbon reforming where the monolith structures are composed of a mixture of one or more dopant metal oxides and one or more structural oxides. The dopant metal(s) and structural oxide(s) are selected based on the relative Gibbs free energy values for the dopant metal oxide and the structural oxide. NiO and Al₂O₃ are described as an example of a suitable combination of a dopant metal oxide and a structural oxide for forming a monolith structure.

U.S. Patent Application Publication 2022/0112082 describes catalyst systems for reforming in cyclic flow reactors. Monoliths for supporting the catalyst systems are also described. Some examples of monoliths are described with compositions corresponding to 93 wt %-95 wt % alumina, 4.0 wt %-5.0 wt % SiO₂, and optionally 1.0 wt %-2.0 wt % of MgO, TiO₂, and/or Na₂O. It is noted that the channels in these monoliths corresponded to square channels.

### SUMMARY OF THE INVENTION

In various aspects, a ceramic monolith is provided. The monolith can be composed of 89.5 wt % to 97.0 wt % α-alumina, 3.0 wt % to 9.0 wt % of dopant oxides comprising SiO₂, MgO, CaO, TiO₂, ZrO₂, HfO₂, Y₂O₃, or a combination thereof, and 1.5 wt % or less of auxiliary oxides comprising Na₂O, SrO, BaO, K₂O, and Fe₂O₃. The monolith can include at least 3.0 wt % of SiO₂. The monolith can have an open frontal area of 30% to 70% and/or a channel density of 50 cells per square inch to 900 cells per square inch. The monolith can further include channels having a cross-section corresponding to a) rounded vertices, the rounded vertices comprising a normalized radius of curvature of 0.15 to 0.65, b) a substantially circular cross-section, or c) a combination of a) and b).

### BRIEF DESCRIPTION OF THE DRAWINGS

FIG. 1 shows examples of cross-sectional shapes for channels in a monolith.

FIG. 2A and FIG. 2B show an example of operation of a reverse flow reactor.

FIG. 3 shows an example of a reverse flow reactor.

FIG. 4A, FIG. 4B, and FIG. 4C show examples of a testing apparatus for exposing monoliths to cyclic heating and cooling.

FIG. 5 shows results from exposing a monolith to cyclic heating and cooling in the test apparatus of FIG. 4.

FIG. 6 shows results from exposing another monolith to cyclic heating and cooling in the test apparatus of FIG. 4.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various aspects, ceramic monolith compositions are provided with improved stability under reaction conditions involving elevated temperatures. Such monoliths can be used, for example, in reverse flow reactors under high temperature reforming conditions, where the interior components of the reaction zone can be exposed to average temperatures of 1000° C. or higher while also being exposed to rapid oscillations in temperature of 100° C. or more in the presence of alternating oxidizing and reducing chemistries. The ceramic monolith compositions can be composed of materials that have improved ability to withstand conditions in severe reaction environments. Additionally or alternately, the ceramic monolith compositions can have structural features that reduce or minimize the tendency for the monolith to suffer structural failure under the conditions in severe reaction environments.

A Reverse Flow Reactor (RFR) is an example of a cyclic flow reactor, where flows introduced into the reactor in roughly opposing directions can be used to create a desirable temperature profile within a reaction environment. In an RFR, heat is efficiently supplied for endothermic reactions, such as reforming, by rapidly cycling with exothermic combustion (a.k.a. regeneration) reactions in the reverse direction. The nature of the RFR reaction environment can provide a variety of advantages in various applications. Such applications can include, but are not limited to, reforming of natural gas to produce blue hydrogen, methane pyrolysis to make acetylene, ethane cracking to produce ethylene, propane dehydrogenation, methane to aromatics production, and other endothermic petrochemical reactions.

Steam reforming is an example of a reaction that can benefit from the cyclic processing environment provided by an RFR. In some aspects, by using pure oxygen, instead of air, to oxy-combust methane and/or other fuel gases within an RFR during the regeneration step, the exhaust gas that is substantially composed of CO₂ and steam can be used to control the flame temperature during regeneration. In this way, the RFR produces syngas and/or hydrogen while capturing CO₂ from the regeneration step in an integrated fashion. In particular, by reducing or minimizing use of air during the regeneration step, the CO₂ generated during combustion is not mixed with nitrogen, thus reducing or minimizing the separation(s) that might need to be performed to capture the CO₂ from combustion as a high purity stream containing 90 vol % or more CO₂, or 95 vol % or more, such as generating an output stream that is substantially composed of CO₂. In addition to simplifying capture of CO₂, use of CO₂ as a sweep and/or carrier gas during regeneration also provides benefits due to the increased heat capacity of CO₂ over nitrogen.

While RFR-type processes offer the potential for improved operation for cyclic high-temperature processes, the nature of such a cyclic high-temperature operating environment can create substantial thermal shock for any components with the environment. Such components can include mixers and/or flame diffusers in the combustion zone and monoliths in the reforming and recuperating zones. In various aspects, monolith compositions are provided that offer improved durability when exposed to high-temperature cyclic reaction environments.

Part of the improved durability for a monolith structure can be achieved based on the composition used to form the monolith. In various aspects, the monolith can be composed primarily of alumina (Al₂O₃). It is noted that due to the high temperature of the sintering used for forming the monolith, the alumina in the monolith can typically be in the form of α-Al₂O₃. In addition to alumina, the monolith composition can also include at least 3.0 wt % of silica (SiO₂). The addition of silica to the alumina can enable manufacturing of honeycomb monolith structures using conventional manufacturing methods such as extrusion. When the silica content falls below 3.0 wt %, it is difficult to extrude or otherwise form desired monolith shapes. More generally, the monolith composition can contain at least 3.0 wt % silica, between 3.0 wt % to 9.0 wt % combined of primary dopant oxides, and 1.5 wt % or less of auxiliary and/or contaminant dopant oxides, with the balance of the composition corresponding to alumina. In some aspects, the monolith composition can contain 3.0 wt % to 9.0 wt % of primary dopant oxides, or 3.0 wt % to 8.0 wt %, or 3.0 wt % to 6.5 wt %, or 4.0 wt % to 9.0 wt %, or 4.0 wt % to 8.0 wt %, or 4.0 wt % to 6.5 wt %. Additionally or alternately, the monolith composition can contain 3.0 wt % to 9.0 wt % of silica, or 3.0 wt % to 8.0 wt %, or 3.0 wt % to 6.5 wt %, or 4.0 wt % to 9.0 wt %, or 4.0 wt % to 8.0 wt %, or 4.0 wt % to 6.5 wt %. Further additionally or alternately, the monolith composition can contain 1.5 wt % or less of auxiliary and/or contaminant dopant oxides, or 1.0 wt % or less, or 0.7 wt % or less, or 0.5 wt % or less, such as down to substantially not containing auxiliary and/or contaminant oxides (0.1 wt % or less). Based on these values, the alumina content of the monolith can be 89.5 wt % to 97 wt %, or 91 wt % to 97 wt %, or 93 wt % to 97 wt %, or 89.5 wt % to 95 wt %.

The primary dopant oxides are SiO₂, MgO, CaO, TiO₂, ZrO₂, HfO₂, and Y₂O₃, and combinations thereof. It is noted that silica is always present in the composition in an amount of at least 3.0 wt %, so when other primary dopant oxides different than silica are present, it will be in the form of a combination of at least two oxides (silica plus at least one other oxide). The auxiliary or contaminant oxides represent additional oxides that may be present, but that typically are present due to use of a lower purity source of alumina, silica, and/or another primary dopant. For example, bauxite ore contains alumina and silica, but can also contain other oxides. If the monolith composition is formed in part using an ore such as bauxite, the auxiliary oxides may be present. The amount of auxiliary oxides and/or contaminant oxides is limited to 1.5 wt % or less, or 1.0 wt % or less, as the auxiliary oxides can tend to form a glassy grain boundary phase in combination with silica and/or other dopant oxides. Such a glassy grain boundary phase represents an interface region with reduced durability under high-temperature cyclic conditions since it acts as an easy pass way for crack propagation and results in inter-granular fracture. Limiting the amount of auxiliary oxides can reduce or minimize the formation of such boundary phases. Examples of auxiliary oxides include SrO, BaO, Na₂O, K₂O, Fe₂O₃, and mixtures thereof.

Additionally or alternately, part of the improved durability for the monolith structures is based on the use of improved channels within the monolith structure. Honeycomb monoliths typically correspond to a monolith structure with a plurality of open channels in the structure that are roughly parallel. The parallel open channels can be coated with a catalyst to provide a large surface area for contact with fluid phase reactants while still offering a reduced or minimized pressure drop across the monolith structure.

Conventionally, the channels within monolith structures have been selected based on channel shapes that can potentially be space filing, such as shapes that can form a tessellation. Thus, rectangular, square, trigonal, trapezoidal, and hexagonal shapes are traditionally used. Such choices provide increased surface area within the channels while reducing or minimizing variations in wall thickness between the channels. By contrast, circular channels are typically avoided. By definition, a two-dimensional collection of circles in a plane has a maximum packing density of roughly 0.9, meaning that roughly 10% of the area corresponds to void space between the circles. From a practical standpoint, the upper bound on the area that can be occupied by circles in a plane places limits on the density of circular cylinder channels that can be achieved while still maintaining a minimum wall thickness for the resulting monolith structure. Additionally, a circular cylinder represents the minimum interior surface area that is available for a channel having a given volume. Thus, monolith channels with circular cross-sections have been avoided conventionally.

It has been discovered that improved durability can be achieved by using alternative channel shapes. In various aspects, the monolith channels in a monolith structure can correspond to a tessellation shape (e.g., square, hexagon) that is modified to have rounded corners, rather than the “pointed” corners present at each vertex of a conventional shape. Without being bound by any particular theory, the vertices of a conventional shape are believed to create stress points within a monolith structure that have higher susceptibility to crack initiation and propagation under high-temperature cyclic conditions. By using channel shapes where the base shape is potentially space-filling but with rounded features at vertices, the creation of stress points is reduced or minimized. In some alternative aspects, due to the benefits of avoiding channel shapes with pointed corners, circular or substantially circular channels can also be used. Even though circular channels are not space filling and reduce available surface area, circular channels can be beneficial in high temperature cyclic environments due to the improved resistance to crack initiation and/or propagation.

In some aspects, monolith structures can be prepared with channels that are based on a shape that can be completely space-filling in two dimensions, but modified to have rounded features at vertices of the shape. Examples of suitable shapes for the channels in a monolith having rounded vertices can include rounded hexagons, rounded squares, and rounded rectangles. For such types of shapes, the cross-section of a channel can correspond to sets of parallel sides with rounded arcs connecting adjacent sides. The size and spacing of the channels can be similar to the size and spacing for conventional channels that do not use rounded vertices.

The rounded vertices can be formed in any convenient manner. In some aspects, the rounded vertices can be have a normalized radius of curvature of 0.15 to 0.65. Per the standard definition, a radius of curvature is defined as the radius of a circular arc that either corresponds to the shape of the rounded vertex, or that corresponds to the best fit circular arc for the rounded vertex (as determined by least squares). After determining a radius of curvature, a normalized radius of curvature can be calculated by dividing the radius of curvature by a characteristic length associated with the channel shape. For channel shapes based on rounded squares or rounded hexagons (or other shapes with regular lengths for the sides), the characteristic length is the distance between the mid-points of two parallel sides. For non-regular shapes such as rectangles, the characteristic length is the average of the distances between parallel sides. It is noted that the radius of curvature can vary between the vertices within an individual channel, so that the channels may not have a completely symmetric shape. As would be expected, the radius of curvature of a circle/substantially circular channel is simply the radius.

It is noted that various types of triangles can also form a tessellation. Thus, rounded triangular cross-sections are also possible for channels. If the channel cross-section is a triangle or another shape that lacks parallel sides, the characteristic length for the channel cross-section is defined as the length of the longest possible straight line segment that connects any two points on the circumference of the channel.

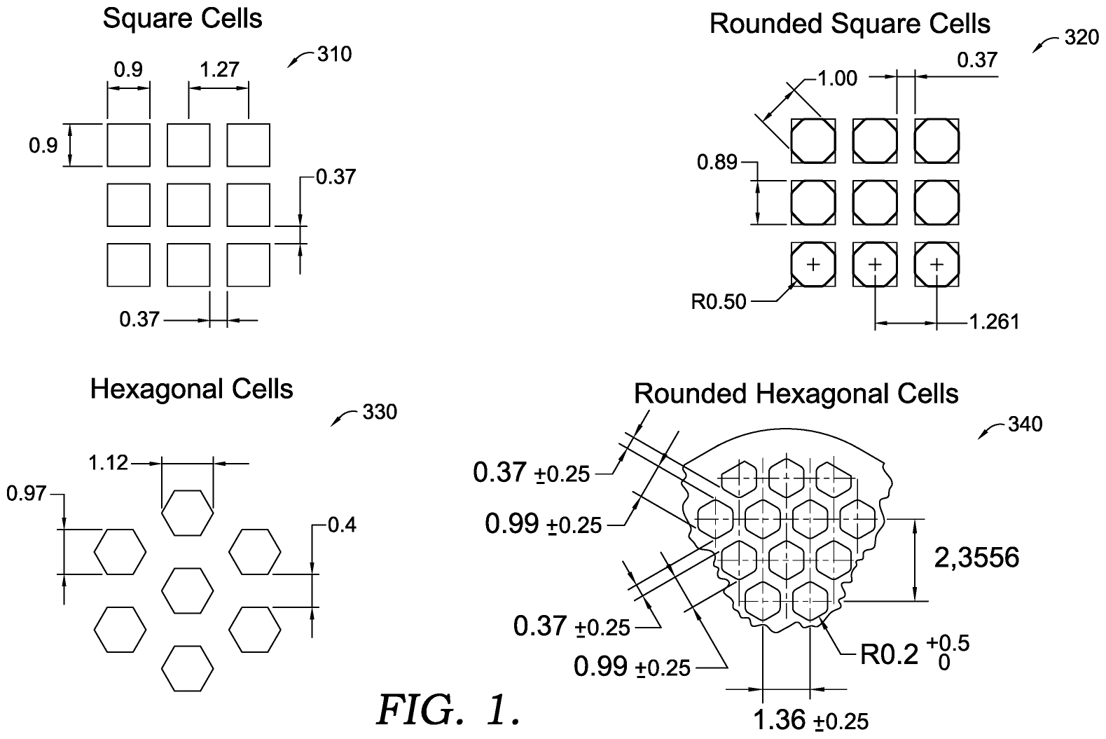

FIG. 1 shows examples of four types of cross-sections for channels in a monolith. The channel cross-sections in FIG. 1 correspond to square channels 310, rounded square channels 320, hexagonal channels 330, and rounded hexagonal channels 340. FIG. 1 also shows dimensions for each type of channel. The dimensions in FIG. 1 are representative of the type of channel size that could be used in a monolith. In other aspects, any convenient channel size can be used that is consistent with the open frontal area for a monolith.

In the example of square channels 310 shown in FIG. 1, the length of the side of a square is 0.9 mm. Thus, the distance between parallel sidewalls of a square is also 0.9 mm. The distance between the sidewalls of adjacent squares (corresponding to the thickness of the wall between the channels) is 0.37 mm, while the distance between the center points of adjacent squares is 1.27 mm. The rounded square channels 320 in FIG. 1 have similar dimensions. The distance between parallel sides for the rounded squares is 0.89 mm. The distance between the sidewalls of adjacent squares is 0.37 mm, while the distance between the center points of adjacent squares is 1.26 mm. Additionally, the radius of curvature for each of the rounded corners is 0.5 mm. This corresponds to a normalized radius of curvature of 0.5/0.89=0.56 (calculated based on radius of curvature divided by distance between parallel sides at the mid-point). It is noted that although the radius of curvature is the same for each rounded corner of the rounded squares in FIG. 1, in other aspects the radius of curvature can vary for rounded corners in different rounded squares and/or for rounded corners within a single rounded square.

In the example of hexagonal channels 330 shown in FIG. 1, the distance between parallel sides of a hexagon is 0.97 mm. The distance between the sidewalls of adjacent hexagons (corresponding to the thickness of the wall between the channels) is 0.40 mm. The rounded hexagon channels 340 in FIG. 1 have similar dimensions. The distance between parallel sides for the rounded hexagons is 0.99 mm. The distance between the sidewalls of adjacent hexagons is 0.37 mm. Additionally, the radius of curvature for each the rounded corners is 0.20 mm. Because the distance between parallel sides is basically 1.0 mm, the normalized radius of curvature for the rounded hexagons is also 0.20. It is noted that although the radius of curvature is the same for each rounded corner of the rounded hexagons in FIG. 1, in other aspects the radius of curvature can vary for rounded corners in different rounded hexagons and/or for rounded corners within a single rounded hexagon.

### Monolith Structure(s) for Supporting Catalyst System

One of the purposes of using a monolith or another supporting structure within a reforming environment is to increase the available surface area for holding a deposited catalyst/catalyst system. To achieve this, some monoliths correspond to a structure with a large plurality of cells or channels that allow gas flow through the monolith. Because each individual cell provides surface area for deposition of catalyst, including a large number of cells or channels per unit area can substantially increase the available surface area for catalyst. Such monoliths can generally be referred to as honeycomb monoliths. It is noted that the terms “cell” and “channel” can be used interchangeably to refer to the passages through a monolith.

In various aspects, a monolith or other structure for providing a surface for the reforming catalyst system may be prepared by manufacturing techniques such as but not limited to conventional ceramic powder manufacturing and processing techniques, e.g., mixing, milling, degassing, kneading, pressing, extruding, casting, drying, calcining, and sintering. The starting materials can correspond to a suitable ceramic powder such as synthetic alumina powder and naturally occurring minerals (e.g. bauxite, bentonite, talc) and an organic binder powder in a suitable volume ratio. Certain process steps may be controlled or adjusted to obtain the desired grain size and porosity range and performance properties, such as by inclusion of various manufacturing, property adjusting, and processing additives and agents as are generally known in the art. For example, the two or more types of oxide powders may be mixed in the presence of an organic binder and one or more appropriate solvents or water for a time sufficient to substantially disperse the powders in each other. As another example, precursors of the oxides present in a monolith may be dissolved in water at a desired ratio, spray dried, and calcined to make a mixed powder. Such precursors include (but are not limited to) chlorides, sulfates, nitrates, and mixtures thereof. The calcined powder can be further mixed in the presence of an organic binder and appropriate solvent(s) to make a mixed “dough”. Then, the mixed “dough” of materials can be placed in a kneader to mix all the ingredient and to enhance plasticity of the mixed “dough”. The number of kneading times and kneading speed can be adjusted. The kneaded “dough” can be placed in a die or form, extruded, dried or otherwise formed into a desired shape. As a non-limiting example, a screw type extruder can be used, and rotation speed of top and bottom screw can be controlled to form a honeycomb shape. As it produces, a wire cutter attached in the screw type extruder operates to make a desired height of the honeycomb monoliths. The resulting extruded body can then be dried to form a “green body”. As a non-limiting example, hot air dryer can be used to slowly remove the residual solvent or water in the extruded body. Yet another non-limiting example, a standalone microwave oven or even a continuous microwave drying oven can be used to form a “green body”. Drying in a microwave oven is advantageous since it shortens total drying time and minimizes potential cracking associated with a rather rapid drying process. The resulting “green body” can then be sintered at temperatures in the range of about 1500° C.˜1700° C. for at least ten minutes, such as from 10 minutes to 48 hours, or possibly from 10 minutes up to 10 days or still longer. Either a batch furnace or a continuous tunnel kiln can be used to sinter the “green body”. During sintering the “green body” shrinks as it densifies and consolidates. The sintering shrinkage is typically about 20˜30%.

The sintering operation may be performed in an oxidizing atmosphere, reducing atmosphere, or inert atmosphere, and at ambient pressure or under vacuum. For example, the oxidizing atmosphere could be air or oxygen, the inert atmosphere could be argon, and a reducing atmosphere could be hydrogen, CO/CO₂ or H₂/H₂O mixtures. Thereafter, the sintered body is allowed to cool, typically to ambient conditions. The cooling rate may also be controlled to provide a desired set of grain and pore structures and performance properties in the particular component.

It is noted that after the sintering operation, any alumina present in the monolith will be substantially converted to α-alumina. The “alpha” phase of alumina is thermodynamically favored at high temperatures, and the temperatures during sintering are sufficient convert substantially all of any other phases of alumina into the “alpha” phase. This is beneficial from a stability standpoint, as converting the alumina in the monolith to α-alumina means that phase transitions are not occurring during exposure of the monolith to the cyclic reforming conditions, where the presence of alternative phases of alumina might facilitate crack formation and/or propagation.

In some aspects, the monolith material (PQ) can further include an intermediate bond layer. The intermediate bond layer can be applied on monolith surfaces prior to forming a washcoat of active materials (e.g., catalyst). In such aspects, the intermediate bond layer provides a better adherence to the washcoated active material. In such aspects, the intermediate bond layer is a metal oxide, (M)ₓO_{y}, wherein (M) is at least one metal selected from the group consisting of Al, Si, Mg, Ca, Sr, Ba, K, Na, Ti, Zr, Hf, V, Nb, Ta, Cr, Mo, W, Mn, Fe, Ni, Co, Y, La, Ce, and mixtures thereof. Aluminum oxide (a.k.a. alumina), Al₂O₃, is a preferred metal oxide for the bond layer. As an example of how to form an intermediate bond layer, the selected metal oxide, (M)ₓO_{y}, can be dispersed in a solution to form a slurry. The slurry can then be washcoated on the monolith. The monolith washcoated with the selected metal oxide, (M)ₓO_{y}, is dried and sintered at temperatures in the range of 1100° C.˜1600° C. to make the intermediate bonding layer.

It has been discovered that limiting the maximum porosity in the final sintered body tends to effectively, if not actually, limit interconnectivity of the pore spaces with other pore spaces to an extent that increases or maximizes volumetric heat capacity of the sintered body. The porosity ranges for a monolith or other structure can depend upon the desired final component performance properties, but are within a range defined by one or more of the minimum porosity values and one or more of the maximum porosity values, or any set of values not expressly enumerated between the minimums and maximums. Examples of suitable porosity values are 0 vol % to 20 vol % porosity, or 0 vol % to 15 vol %, or 0 vol % to 10 vol %, or 0 vol % to 5 vol %.

The sintered monolith and/or other formed ceramic structure can have any convenient shape suitable for use as a surface for receiving a catalyst or catalyst system. An example of a monolith can be an extruded honeycomb monolith. Honeycomb monoliths can be extruded structures that comprise many (e.g., a plurality, meaning more than one) small gas flow passages or conduits, arranged in parallel fashion with thin walls in between. A small reactor may include a single monolith, while a larger reactor can include a number of monoliths, while a still larger reactor may be substantially filled with an arrangement of many honeycomb monoliths. Each monolith may be formed by extruding monolith blocks with shaped (e.g., square, trigonal, or hexagonal) cross-section and two- or three-dimensionally stacking such blocks above, behind, and beside each other. Monoliths can be attractive as reactor internal structures because they provide high heat transfer capacity with minimum pressure drop.

In some aspects, density, measured by an Archimedes method well-known to the skilled in the art, can be 3.40 gram/cc or more, or 3.50 gram/cc or more, such as up to 3.95 gram/cc which is theoretical density of alumina, or possibly still higher if it contains heavier metal oxides. In some aspects, porosity can be nearly completely closed within the honeycomb monolith walls with the porosity being 10% or less, or 8.0% or less, such as down to 1.0% or possibly still lower.

In some aspects, honeycomb monoliths can be characterized as having open frontal area (or geometric void volume) between 30% to 70%, or 30% to 60%, or 40% to 70%, or 40% to 60%, or 45% to 55%. Additionally or alternately, a monolith can have a conduit density between 50 to 900 cells per square inch (CPSI), or 50 to 600, or 300 to 900, or 300 to 600, or 350 to 550. This roughly corresponds to 7 to 140 cells per square centimeter, or 45 to 140, or 7 to 95, or 45 to 95, or 55 to 85. In some aspects, this type of cell density roughly corresponds to cells or channels that have a diameter/characteristic cell side length of only a few millimeters, such as on the order of roughly one millimeter. Reactor media components, such as the monoliths or alternative bed media, can provide for channels that include a packing with an average wetted surface area per unit volume that ranges from 50 ft⁻¹ to 3000 ft⁻¹ (˜0.16 km⁻¹ to ˜10 km⁻¹), or from 100 ft⁻¹ to 2500 ft⁻¹ (˜0.32 km⁻¹ to ˜8.2 km⁻¹), or from 200 ft⁻¹ to 2000 ft⁻¹ (˜0.65 km⁻¹ to ˜6.5 km⁻¹), based upon the volume of the first reactor that is used to convey a reactant. These relatively high surface area per unit volume values can aid in achieving a relatively quick change in the temperature through the reactor.

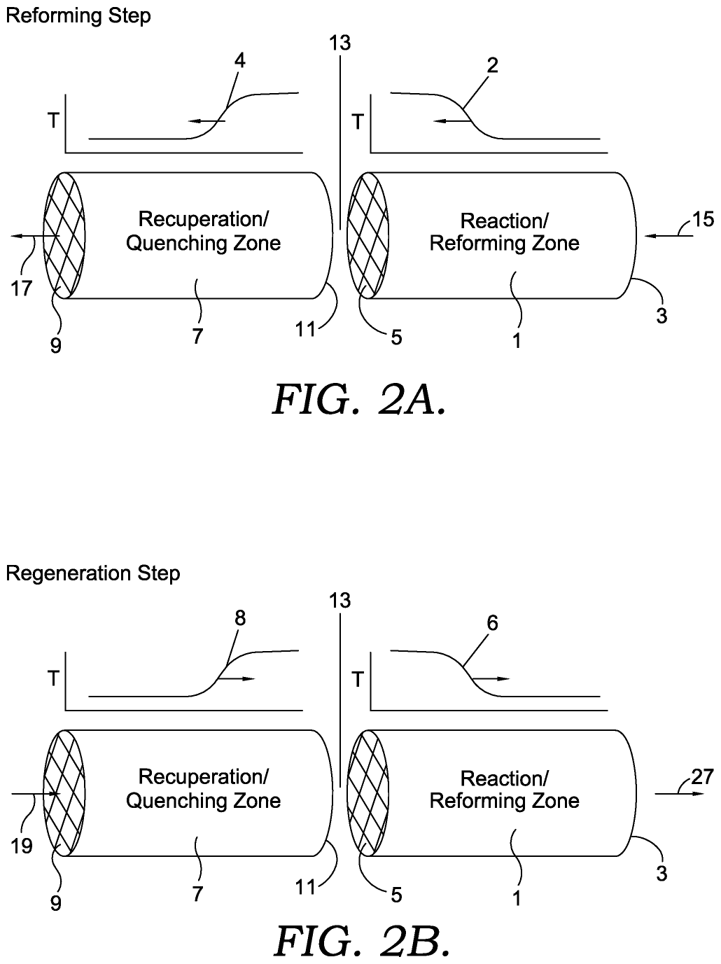

Reactor media components can also provide for channels that include a packing that includes a high volumetric heat transfer coefficient (e.g., 0.02 cal/cm³s° C. or more, or 0.05 cal/cm³s° C. or more, or 0.10 cal/cal/cm³s° C. or more); that have low resistance to flow (low pressure drop); that have an operating temperature range consistent with the highest temperatures encountered during regeneration; that have high resistance to thermal shock; and/or that have high bulk heat capacity (e.g., 0.10 cal/cm³s° C. or more, or 0.20 cal/cm³s° C. or more). As with the high surface area values, these relatively high volumetric heat transfer coefficient values and/or other properties can aid in achieving a relatively quick change in the temperature through the reactor, such as generally illustrated by the relatively steep slopes in the exemplary temperature gradient profile graphs, such as in FIGS. 2A and 2B of FIG. 2. The cited values are averages based upon the volume of reactor used for conveyance of a reactant.

In various aspects, adequate heat transfer rate can be characterized by a heat transfer parameter, ΔTHT, below 500° C., or below 100° C., or below 50° C. The parameter ΔTHT, as used herein, is the ratio of the bed-average volumetric heat transfer rate that is needed for recuperation, to the volumetric heat transfer coefficient of the bed, hv. The volumetric heat transfer rate (e.g. cal/cm³ sec) that is sufficient for recuperation can be calculated as the product of the gas flow rate (e.g. g/sec) with the gas heat capacity (e.g. cal/g° C.) and desired end-to-end temperature change (excluding any reaction, e.g. ° C.), and then this quantity can be divided by the volume (e.g. cm³) of the reactor (or portion of a reactor) traversed by the gas. The volumetric heat transfer coefficient of the bed, hv, can typically be calculated as the product of an area-based coefficient (e.g. cal/cm²s° C.) and a specific surface area for heat transfer (av, e.g. cm²/cm³), often referred to as the wetted area of the packing.

### Catalysts and Catalyst Systems

In various aspects, catalyst systems are provided for reforming of hydrocarbons, along with methods for using such catalyst systems. The catalyst systems can be deposited or otherwise coated on a surface or structure, such as a monolith, to achieve improved activity and/or structural stability. In this discussion, a catalyst system is defined to include at least one catalyst corresponding to one or more catalytic metals, optionally in the form of a metal oxide, and at least one metal oxide support layer. In some aspects, the catalyst and metal oxide support layer can be coated on the monolith at the same time, such as in the form of a washcoat layer on the support. In such aspects, the catalyst can be intermixed with the metal oxide support layer. Alternatively, the catalyst and metal oxide support layer can be deposited sequentially so that the support layer is deposited first, followed by the catalyst. In some aspects, the metal oxide support layer can correspond to a thermally stable metal oxide support layer, such as a metal oxide support layer that is thermally phase stable at temperatures of 800° C. to 1600° C. Optionally, an intermediate bonding layer can be applied to at least a portion of the monolith or other structure prior to depositing the catalyst system. The catalyst systems can be beneficial for use in cyclical reaction environments, such as reverse flow reactors or other types of reactors that are operated using flows in opposing directions and different times within a reaction cycle. The reaction conditions in cyclical reaction environments can also undergo swings in temperature and/or pressure during a reaction cycle. In still other aspects, a catalyst can be deposited without using a corresponding metal oxide support layer.

In some aspects, the catalyst system can correspond to one or more catalysts in a single zone. In other aspects, the catalyst system can correspond to a plurality of catalyst zones. Optionally in such aspects, at least one catalyst zone can include a catalyst that is different from the catalyst(s) in a second catalyst zone.

In some aspects, the catalyst system can include a thermally stable metal oxide support layer. A thermally stable metal oxide support layer corresponds to a metal oxide that is thermally phase stable with regard to structural phase changes at temperatures between 800° C. to 1600° C. In some aspects, such a thermally stable metal oxide support layer can be formed by coating a surface (such using a washcoat) with a metal oxide powder that has a surface area of 20 m²/g or less. For example, the metal oxide powder used for forming a thermally stable metal oxide coating can have a surface area of 0.5 m²/g to 20 m²/g, or 1.0 m²/g to 20 m²/g, or 5.0 m²/g to 20 m²/g. High temperature reforming refers to reforming that takes place at a reforming temperature of 1000° C. or more, or 1100° C. or more, or 1200° C. or more, such as up to 1500° C. or possibly still higher. In various aspects, a catalyst can be annealed at a temperature of 1000° C. or more, or 1100° C. or more, or 1200° C. or more, or 1300° C. or more, such as up to 1600° C. or possibly still higher. This temperature can be substantially similar to or greater than the peak temperature the catalyst is exposed to during a reforming process cycle. An annealing temperature that is substantially similar to a peak temperature can correspond to an annealing temperature that differs from the peak temperature by 0° C. to 50° C.

As an example of a thermally stable metal oxide support layer, alumina has a variety of phases, including α-Al₂O₃, γ-Al₂O₃, and θ-Al₂O₃. A metal powder of α-Al₂O₃ can typically have a surface area of 20 m²/g or less. By contrast, the γ-Al₂O₃ and θ-Al₂O₃ phases have higher surface areas, and a metal powder for use in a washcoat solution of γ-Al₂O₃ and/or θ-Al₂O₃ will have a surface area of greater than 20 m²/g. It is conventionally believed that phases such as θ-alumina or γ-alumina are superior as a supporting structure for a deposited catalyst, as the greater surface per gram of θ-alumina or γ-alumina will allow for availability of more catalyst active sites than α-alumina. However, phases such as γ-Al₂O₃ and θ-Al₂O₃ are not thermally phase stable at temperatures of 800° C. to 1600° C. At such high temperatures, phases such as γ-Al₂O₃ and θ-Al₂O₃ will undergo phase transitions to higher stability phases. For example, at elevated temperatures, γ-Al₂O₃ will first convert to Δ-Al₂O₃ at roughly 750° C.; then Δ-Al₂O₃ will convert to θ-Al₂O₃ at roughly 950° C.; then O—Al₂O₃ will then convert to α-Al₂O₃ with further exposure to elevated temperatures between 1000° C. and 1100° C. Thus, α-Al₂O₃ is the thermally phase stable version of Al₂O₃ at temperatures of 800° C. to 1600° C.

In various aspects, one option for adding a catalyst sytem to a monolith can be to coat the monolith with a mixture of a catalyst (optionally in oxide form) and metal oxide support layer. For example, powders of the catalyst oxide and the metal oxide support layer can be used to form a washcoat that is then applied to the monolith (or other structure). This can result in a catalyst system where the catalyst is mixed within/distributed throughout the metal oxide support layer, as opposed to the catalyst being deposited on top of the metal oxide support layer. In other words, at least a portion of the catalyst system can correspond to a mixture of the catalyst and the support layer. In other aspects, any convenient method for depositing or otherwise coating the catalyst system on the monolith or other structure can be used. The weight of the catalyst system on the monolith (or other structure) can correspond to 0.1 wt % to 10 wt % of the total weight of the catalyst system plus monolith, or 0.5 wt % to 10 wt %, or 2.0 wt % to 10 wt %, or 0.1 wt % to 6.0 wt %, or 0.5 wt % to 6.0 wt %, or 2.0 wt % to 6.0 wt %.

A catalyst system can be applied to a monolith or other structure, for example, by applying the catalyst system as a washcoat suspension. To form a washcoat suspension, the catalyst system can be added to water to form an aqueous suspension having 10 wt % to 50 wt % solids. For example, the aqueous suspension can include 10 wt % to 50 wt % solids, or 15 wt % to 40 wt %, or 10 wt % to 30 wt %. Optionally, an acid or a base can be added to the aqueous suspension to reduce or raise, respectively, the pH so as to change the particle size distribution of the alumina catalyst and/or binder particles. For example, acetic acid or another organic acid can be added to achieve a pH of 3 to 4. The suspension can then be ball milled (or processed in another manner) to achieve a desired particle size for the catalyst particles, such as a particle size of 0.5 μm to 5 μm. After milling, the suspension can be stirred until time for use so that the particles are distributed substantially uniformly in the solution.

The washcoat suspension can then be applied to a monolith structure to achieve a desired amount of catalyst (such as nickel or rhodium) on the monolith surface. As an example, in one aspect a washcoat thickness of 10 microns was achieved by forming a washcoat corresponding to 10 wt % of the monolith structure. Any convenient type of monolith structure can be used to provide a substantial surface area for support of the catalyst particles. The washcoat can be applied to the monolith to form cells having inner surfaces coated with the catalyst. One option for applying the washcoat can be to dip or otherwise submerge the monolith in the washcoat suspension.

After clearing the cell channels of excess washcoat, the catalyst system coated on the monolith can be optionally dried. Drying can correspond to heating at 100° C. to 200° C. for 0.5 hours to 24 hours. After any optional drying, calcination can be performed. In some aspects, calcining can correspond to heating at 200° C. to 800° C. for 0.5 hours to 24 hours. In some other aspects, calcining can correspond to heating at 800° C. to 1300° C. for 0.5 hours to 24 hours.

In other aspects, a high temperature calcination step can be used, so that the calcining temperature for the catalyst system coated on the monolith is substantially similar to or greater than the peak temperature the monolith will be exposed to during the cyclic high temperature reforming reaction. For a monolith in a high temperature zone, this can correspond to calcining the catalyst system coated on the monolith at a temperature of 800° C. or more, or 1000° C. or more, or 1200° C. or more, or 1300° C. or more, such as up to 1600° C. or possibly still higher. It is noted that if multiple catalyst zones are present, the calcination for monoliths in different catalyst zones can be different.

It has been unexpectedly discovered that performing calcination at a temperature similar to or greater than the peak temperature during the cyclic high temperature reforming process can unexpectedly allow for improved activity for the catalyst system and/or adhesion of the catalyst system to the underlying monolith. Without being bound by any particular theory, it is believed that exposing the monolith and deposited catalyst system to elevated temperatures prior to exposure of the catalyst to a cyclic reaction environment can facilitate forming a stable interface between the catalyst system and the monolith. This stable interface can then have improved resistance to the high temperature oxidizing and/or reducing environment during the reforming process, resulting in improved stability for maintaining the catalyst system on the surface of the monolith.

One of the distinctions between using a catalyst system including a thermally stable metal oxide and a catalyst system that does not use a thermally stable oxide is that the catalyst system including the thermally stable metal oxide can have improved adhesion to the underlying support structure after exposure to the cyclic high temperature reforming environment.

Adhesion of the washcoat after operation can be quantified by the amount of force needed to de-adhere the washcoat. In prior operation, washcoats comprised of theta and gamma alumina were de-adhered with minimal force, such as an amount of force similar to a paint brush stroke (weak). In operation with the phase stable supports, the force needed to de-adhere the washcoat was high, similar to the scraping of dried epoxy off of a glass surface (strong). Due to these differences, only small amounts of washcoat could be de-adhered from the phase stable materials, whereas large amounts of washcoat could be de-adhered from the gamma and theta supports.

Other methods for evaluating adhesion of the washcoat include, but are not limited to, (i) a thermal cycling method, (ii) a mechanical attrition method, and (iii) an air-knife method. As a non-limiting example, the thermal cycling method can be performed by heating the washcoated materials to high temperatures in the range of 800 to 1300° C., cooling the heated substrates to ambient temperature, and repeating such a cycle at least five times. As another non-limiting example, the mechanical attrition method can be performed by placing the washcoated materials inside a plastic container and shaking the container on a vibration table for at least 30 minutes.

In various aspects, suitable catalytic metals can include, but are not limited to, Ni, Co, Fe, Pd, Rh, Ru, Pt, Ir, Cu, Ag, Au, Zr, Cr, Ti, V, Mo, Nb, and combinations thereof. The catalytic metal can be selected based on the desired type of catalytic activity. Such catalytic metals may be used in a catalyst in the form of a metal oxide. In some aspects, for reforming of hydrocarbons in the presence of H₂O and/or CO₂ to make hydrogen, Ni, Rh, Ru, Pd, Pt, Ir, Cu, Co, or a combination of thereof can be suitable catalytic metals. The weight of catalytic metal oxide in the catalyst system can range from 0.1 wt % to 70 wt %, or 1.0 wt % to 60 wt %, or 2.0 wt % to 50 wt %, relative to the total weight of the catalyst system. In some aspects where the catalytic metal corresponds to a precious metal or noble metal, the weight of catalytic metal oxide in the catalyst system can range from 0.1 wt % to 10 wt %, or 0.2 wt % to 7.0 wt %, or 0.5 wt % to 4 wt %.

The catalytic metals can be selected to provide long term stable performance at specific temperature zones of the catalytic bed. This can allow for steady methane conversion, phase stability with the metal oxide support, and reduced or minimized sintering of catalytic metals. As an example involving three catalyst zones, the catalyst system in a highest temperature catalytic zone (e.g. 800˜1250° C.), which is exposed to some of highest temperatures and most severe temperature swings, can be composed of Ni as a catalytic metal (NiO as a catalytic metal oxide) and Al₂O₃ as a metal oxide support. It is noted that this catalyst system can at least partially convert to NiAl₂O₄ during portions of the cyclic reforming process. This catalyst system can be formed, for example, by using a mixture of NiO and Al₂O₃, as a washcoat on α-Al₂O₃ monoliths. In such an example, a catalyst system in a medium temperature catalytic zone (e.g. 600˜1150° C.) can be composed of Ni and Rh as catalytic metals (NiO and Rh₂O₃ as catalytic metal oxide), and Al₂O₃ as a metal oxide support. To form this catalyst system, a mixture of NiO and Rh₂O₃, as the catalytic material and Al₂O₃ (optionally but preferably α-Al₂O₃) as a metal oxide support material can be washcoated on a monolith comprising of 95 wt % α-Al₂O₃, 4 wt % SiO₂ and 1 wt % TiO₂. In such an example, a catalyst system in a low temperature catalytic zone (e.g. 400˜1050° C.) can be composed of Rh as catalytic metal (Rh₂O₃ as catalytic metal oxide) and α-Al₂O₃ as a metal oxide support. To form this catalyst system, a mixture of Rh₂O₃ and α-Al₂O₃ as the catalytic material can be washcoated on a monolith comprising 93 wt % α-Al₂O₃, 5 wt % SiO₂ and 2 wt % MgO.

In various aspects, suitable metals for the metal oxide support layer in the catalyst system can include, but are not limited to, Al, Si, Mg, Ca, Sr, Ba, K, Na, Ti, Zr, Hf, V, Nb, Ta, Cr, Mo, W, Mn, Fe, Ni, Co, Y, La, Ce, and combinations thereof. The metal (or metals) for the metal oxide support can be selected so that the metal oxide support substantially does not convert to metallic form under the reducing conditions present in the cyclic reaction environment. As an example, when the catalytic metal oxide is NiO, one option for a metal oxide support is Al₂O₃, preferably α-Al₂O₃. Another example of a suitable metal oxide support, optionally, in combination with NiO as the catalytic metal oxide, is a mixture of Al₂O₃ with SiO₂, MgO and/or TiO₂. In such an example, SiO₂ can combine with Al₂O₃ to form a mullite phase that could increase resistance to thermal shock and/or mechanical failure. Additionally or alternately, in such an example, MgO and/or TiO₂ can be added. The weight of metal oxide support in the catalyst bed can range from 1.0 wt % to 40 wt %, or 2.0 wt % to 30 wt %, or 3.0 wt % to 20 wt %, relative to the total weight of the monolith in the catalyst bed.

In various aspects, a metal oxide support layer (such as a thermally stable metal oxide support layer) can correspond to at least one oxide selected from the corundum group, stabilized zirconia, perovskite, pyrochlore, spinel, hibonite, zeolite, and mixtures thereof. The weight of metal oxide support can range from 1.0 wt % to 40 wt %, or 2.0 wt % to 30 wt %, or 3.0 wt % to 20 wt %, relative to the total weight of the monolith plus catalyst system.

One category of metal oxide support layers can correspond to traditional refractory oxides that are commonly used to form supported catalysts. For example, the metal oxide support can correspond to α-Al₂O₃, LaAlO₃, LaAl₁₁O₁₈, MgO, CaO, ZrO₂, TiO₂, CeO₂, Y₂O₃, La₂O₃, SiO₂, Na₂O, K₂O, and mixtures thereof. This group is defined herein as the “corundum” group of oxides, although many of the oxides in this group do not have the corundum lattice structure. For example, CeO₂ and MgO can both have a halite crystal structure. α-Al₂O₃ consists essentially of a dense arrangement of oxygen ions in hexagonal closest-packing with Al³⁺ ions in two-thirds of the available octahedral sites. LaAlO₃, often abbreviated as LAO, is an optically transparent ceramic oxide with a distorted perovskite structure. LaAl₁₁O₁₈ can be formed through the solid state reaction of LaAlO₃ and α-Al₂O₃. Plate-like crystals of LaAl₁₁O₁₈ are particularly useful as a metal oxide support since catalytic metals can be trapped between plate-like crystal structures. It suppresses sintering of minute catalytic metals in the active material which is washcoated on the monolith of the catalyst bed. Additional examples of oxides from the corundum group can include, but are not limited to: i) 95 wt % α-Al₂O₃ and 5 wt % SiO₂; ii) 93 wt % α-Al₂O₃, 5 wt % SiO₂ and 2 wt % MgO; iii) 94 wt % α-Al₂O₃, 4 wt % SiO₂, 2 wt % MgO and 1 wt % Na₂O; iv) 95 wt % α-Al₂O₃, 4 wt % SiO2 and 1 wt % TiO₂; v) 7 wt % CeO₂ and 93 wt % MgO; vi) 5 wt % CaO and 95 wt % α-Al₂O₃; vii) 5 wt % MgO, 5 wt % CeO₂ and 90 wt % α-Al₂O₃; viii) 20 wt % ZrO₂ and 80 wt % CeO₂, ix) 5 wt % CeO₂, 20 wt % ZrO₂ and 75 wt % α-Al₂O₃, and x) 6 wt % La₂O₃ and 94 wt % α-Al₂O₃, based on the weight of metal oxide support.

As an example, the catalyst system can correspond to a mixture of NiO and Al₂O₃. Under the cyclic high temperature reforming conditions, the NiO and the Al₂O₃ in the will react to form a mixed phase of NiO, NiAl₂O₄, and/or Al₂O₃. Additionally, based on cyclic exposure to oxidizing and reducing conditions, the catalyst can be converted from a substantially fully oxidized state, such as a combination of oxides including NiO, NiAl₂O₄ and Al₂O₃, to various states including at least some Ni metal supported on a surface. In this discussion, a catalyst system that includes both NiO and Al₂O₃ is referred to as an NiAl₂O₄ catalyst system.

Based on the stoichiometry for combining NiO and Al₂O₃ to form NiAl₂O₄, a catalyst including a molar ratio of Al to Ni of roughly 2.0 (i.e., a ratio of 2:1) could result in formation of NiAl₂O₄ with no remaining excess of NiO or Al₂O₃. Thus, one option for forming an NiAl₂O₄ catalyst is to combine NiO and Al₂O₃ to provide a stoichiometric molar ratio of Al to Ni of roughly 2.0. In some other aspects, an excess of NiO can be included in the catalyst relative to the amount of alumina in the support, so that at least some NiO is present in a fully oxidized state. In such aspects, the molar ratio of Al to Ni in the catalyst can be less than 2.0. For example, the molar ratio of Al to Ni in a NiO/NiAl₂O₄ catalyst can be 0.1 to 2.0, or 0.1 to 1.9, or 0.1 to 1.5, or 0.5 to 2.0, or 0.5 to 1.9, or 0.5 to 1.5, or 1.0 to 2.0, or 1.0 to 1.9, or 1.2 to 1.5, or 1.5 to 2.0, or 1.5 to 1.9. In still other aspects, an excess of Al₂O₃ can be included in the catalyst relative to the amount of Ni, so that at least some Al₂O₃ is present in a fully oxidized state. In such aspects, the molar ratio of Al to Ni in the catalyst can be greater than 2.0. For example, the molar ratio of Al to Ni in a NiAl₂O₄/Al₂O₃ catalyst can be 2.0 to 10, or 2.1 to 10, or 2.0 to 5.0, or 2.1 to 5.0, or 2.0 to 4.0, or 2.1 to 4.0.

In various aspects, a NiAl₂O₄ catalyst can be incorporated, for example, into a washcoat that is then applied to a surface or structure within a reactor, such as a monolith. By providing NiO and Al₂O₃ as a catalyst system that is then deposited on a separate monolith (which can then form NiAl₂O₄ under the cyclic conditions), the activity of the catalyst can be maintained for unexpectedly longer times relative to using a monolith that directly incorporates NiO and Al₂O₃ into the monolith structure.

When a composition is formed that includes both nickel oxide and alumina, the NiO and Al₂O₃ can react to form a compound corresponding to NiAl₂O₄. However, when NiO (optionally in the form of NiAl₂O₄) is exposed to reducing conditions, the divalent Ni can be reduced to form metallic Ni. Thus, under cyclic reforming conditions that include both high temperature oxidizing and reforming environments, at least a portion of NiAl₂O₄ catalyst can undergo cyclic transitions between states corresponding to Ni metal and Al₂O₃ and NiAl₂O₄. It is believed that this cyclic transition between states can allow a NiAl₂O₄ catalyst to provide unexpectedly improved activity over extended periods of time. Without being bound by any particular theory, it is believed that at least part of this improved activity for extended time periods is due to the ability of Ni to “re-disperse” during the successive oxidation cycles. It is believed this re-dispersion occurs in part due to the formation of NiAl₂O₄ from NiO and Al₂O₃. Catalyst sintering is a phenomenon known for many types of catalysts where exposure to reducing conditions at elevated temperature can cause catalyst to agglomerate on a surface. Thus, even if the surface area of the underlying surface remains high, the agglomeration of the catalyst may reduce the amount of available catalyst active sites, as the catalyst sinters and forms lower surface area deposits on the underlying surface. By contrast, it is believed that the cyclic transition between states can allow the Ni in an NiAl₂O₄ catalyst system to retain good dispersion, so that catalyst activity can be maintained. It is believed that further advantage can be obtained by using a sufficient amount of excess oxygen during the regeneration step so that all available Ni is oxidized back to NiO and/or NiAl₂O₄.

It is noted that by supplying both NiO as a catalyst and Al₂O₃ as a metal oxide support layer as part of the catalyst system, the alumina for forming NiAl₂O₄ is already provided as part of the catalyst system. It is believed that this reduces or minimizes interaction of Ni with any alumina that may be present in the monolith composition, and therefore reduces or minimizes degradation of the underlying monolith when exposed to successive cycles of high temperature oxidation and reduction.

NiO supported on yttria-stabilized zirconia (NiO/YSZ) is another example of an Ni-containing catalyst system that can be used for reforming. Although α-Al₂O₃ is phase stable, it is able to react with NiO at high temperature to form NiAl₂O₄. It is believed, however, that YSZ does not react with Ni (NiO) at high temperatures. Thus, it is believed that in the NiO/YSZ system, a cyclic oxidation and reduction of Ni to NiO and back to Ni metal does occur, but redispersion does not occur. However, NiO/YSZ can still provide stable reforming activity in a cyclic high temperature reforming environment. In some aspects, to assist with bonding of NiO/YSZ to a monolith, an intermediate oxide layer of α-Al₂O₃ can first be deposited as a washcoat on the monolith. The NiO/YSZ layer can then be deposited on the intermediate oxide layer.

NiO/YSZ represents an alternative type of catalyst system, as YSZ is a phase stable support that does not react with Ni to form a different material. In order to determine stability of the support oxide layer, a first sample of NiO/YSZ was exposed to calcining at 1300° C., while a second sample was steamed in air at 1000° C. X-ray diffraction was used to verify that no phase changes occurred. However, based on Brunauer-Emmett-Teller (BET) surface area analysis, it was observed that the surface area of the NiO/YSZ sample was roughly 53 m²/g prior to the calcining and steaming, and roughly 5 m²/g after the calcining and steaming.

Still another example of a catalyst system containing Ni can be NiO on a perovskite oxide, such as Sr_{0.65}La_{0.35}TiO₃ (SLT).

### Process Example—Reverse Flow Reforming and Regeneration

In various aspects, reforming of hydrocarbons can be performed under steam reforming conditions in the presence of H₂O, under dry reforming conditions in the presence of CO₂, or under conditions where both H₂O and CO₂ are present in the reaction environment. As a general overview of operation during reforming in a swing reactor, such as a reverse flow reactor, a regeneration step or portion of a reaction cycle can be used to provide heat for the reactor. Reforming can then occur within the reactor during a reforming step or portion of the cycle, with the reforming reaction consuming heat provided during the reactor regeneration step. During reactor regeneration, fuel and an oxidant are introduced into the reactor from a regeneration end of the reactor. The bed and/or monoliths in the regeneration portion of the reactor can absorb heat, but typically do not include a catalyst for reforming. As the fuel and oxidant pass through the regeneration section, heat is transferred from the regeneration section to the fuel and oxidant. Combustion does not occur immediately, but instead the location of combustion is controlled to occur in a middle portion of the reactor. The flow of the reactants continues during the regeneration step, leading to additional transfer of the heat generated from combustion into the reforming end of the reactor.

After a sufficient period of time, the combustion reaction is stopped. Any remaining combustion products and/or reactants can optionally be purged. The reforming step or portion of the reaction cycle can then start. The reactants for reforming can be introduced into the reforming end of the reactor, and thus flow in effectively the opposite direction relative to the flow during regeneration. The bed and/or monoliths in the reforming portion of the reactor can include a catalyst for reforming. In various aspects, at least a portion of the catalyst can correspond to a catalyst formed from a ceramic composition as described herein. As reforming occurs, the heat introduced into the reforming zone during combustion can be consumed by the endothermic reforming reaction. After exiting the reforming zone, the reforming products (and unreacted reactants) are no longer exposed to a reforming catalyst. As the reforming products pass through the regeneration zone, heat can be transferred from the products to the regeneration zone. After a sufficient period of time, the reforming process can be stopped, remaining reforming products can optionally be collected or purged from the reactor, and the cycle can start again with a regeneration step.

The reforming reaction performed within the reactor can correspond reforming of methane and/or other hydrocarbons using steam reforming, in the presence of H₂O; using dry reforming, in the presence of CO₂, or using “bi” reforming in the presence of both H₂O and CO₂. Examples of stoichiometry for steam, dry, and “bi” reforming of methane are shown in equations (1)-(3).

Dry Reforming: CH₄+CO₂=2CO+2H₂ (1)

Steam Reforming: CH₄+H₂O=CO+3H₂ (2)

Bi Reforming: 3CH₄+2H₂O+CO₂=4CO+8H₂. (3)

As shown in equations (1)-(3), dry reforming can produce lower ratios of H₂ to CO than steam reforming. Reforming reactions performed with only steam can generally produce a ratio of H₂ to CO of around 3, such as 2.5 to 3.5. By contrast, reforming reactions performed in the presence of CO₂ can generate much lower ratios, possibly approaching a ratio of H₂ to CO of roughly 1.0 or even lower. By using a combination of CO₂ and H₂O during reforming, the reforming reaction can potentially be controlled to generate a wide variety of H₂ to CO ratios in a resulting syngas.

It is noted that the ratio of H₂ to CO in a synthesis gas can also be dependent on the water gas shift equilibrium. Although the above stoichiometry shows ratios of roughly 1 or roughly 3 for dry reforming and steam reforming, respectively, the equilibrium amounts of H₂ and CO in a synthesis gas can be different from the reaction stoichiometry. The equilibrium amounts can be determined based on the water gas shift equilibrium, which relates the concentrations of H₂, CO, CO₂ and H₂O based on the reaction

H₂O+CO<=>H₂+CO₂ (4)

Most reforming catalysts, such as rhodium and/or nickel, can also serve as water gas shift catalysts. Thus, if reaction environment for producing H₂ and CO also includes H₂O and/or CO₂, the initial stoichiometry from the reforming reaction may be altered based on the water gas shift equilibrium. This equilibrium is also temperature dependent, with higher temperatures favoring production of CO and H₂O. It is noted that higher temperatures can also improve the rate for reaching equilibrium. As a result, the ability to perform a reforming reaction at elevated temperatures can potentially provide several benefits. For example, instead of performing steam reforming in an environment with excess H₂O, CO₂ can be added to the reaction environment. This can allow for both a reduction in the ratio of H₂ to CO produced based on the dry reforming stoichiometry as well as a reduction in the ratio of H₂ to CO produced based on the water gas shift equilibrium. Alternatively, if a higher H₂ to CO ratio is desired, CO₂ can be removed from the environment, and the ratio of H₂O to CH₄ (or other hydrocarbons) can be controlled to produce a desirable type of synthesis gas. This can potentially allow for generation of a synthesis gas having a H₂ to CO ratio of 0.1 to 15, or 0.1 to 3.0, or 0.5 to 5.0, or 1.0 to 10, by selecting appropriate amounts of feed components.

The reforming reactions shown in equations (1)-(3) are endothermic reactions. One of the challenges in commercial scale reforming can be providing the heat for performing the reforming reaction in an efficient manner while reducing or minimizing introduction of additional components into the desired synthesis gas product. Cyclic reaction systems, such as reverse flow reactor systems, can provide heat in a desirable manner by having a cycle including a reforming step and a regeneration step. During the regeneration step, combustion can be performed within a selected area of the reactor. A gas flow during regeneration can assist with transferring this heat from the combustion zone toward additional portions of the reforming zone in the reactor. The reforming step within the cycle can be a separate step, so that incorporation of products from combustion into the reactants and/or products from reforming can be reduced or minimized. The reforming step can consume heat, which can reduce the temperature of the reforming zone. As the products from reforming pass through the reactor, the reforming products can pass through a second zone that lacks a reforming or water gas shift catalyst. This can allow the reaction products to cool prior to exiting the reactor. The heat transferred from the reforming products to the reactor can then be used to increase the temperature of the reactants for the next combustion or regeneration step.

One common source for methane is natural gas. In some applications, natural gas, including associated hydrocarbon and impurity gases, may be used as a feed for the reforming reaction. The supplied natural gas also may be sweetened and/or dehydrated natural gas. Natural gas commonly includes various concentrations of associated gases, such as ethane and other alkanes, preferably in lesser concentrations than methane. The supplied natural gas may include impurities, such as H₂S and nitrogen. More generally, the hydrocarbon feed for reforming can include any convenient combination of methane and/or other hydrocarbons. Optionally, the reforming feed may also include some hydrocarbonaceous compounds, such as alcohols or mercaptans, which are similar to hydrocarbons but include one or more heteroatoms different from carbon and hydrogen. In some aspects, an additional component present in the feed can correspond to impurities such as sulfur that can adsorb to the catalytic monolith during a reducing cycle (such as a reforming cycle). Such impurities can be oxidized in a subsequent cycle to form sulfur oxides, which can then be reduced to release additional sulfur-containing components (or other impurity-containing components) into the reaction environment.

In some aspects, the feed for reforming can include, relative to a total weight of hydrocarbons in the feed for reforming, 5 wt % or more of C₂±compounds, such as ethane or propane, or 10 wt % or more, or 15 wt % or more, or 20 wt % or more, such as up to 50 wt % or possibly still higher. It is noted that nitrogen and/or other gases that are non-reactive in a combustion environment, such as H₂O and CO₂, may also be present in the feed for reforming. In aspects where the reformer corresponds to an on-board reforming environment, such non-reactive products can optionally be introduced into the feed, for example, based on recycle of an exhaust gas into the reformer. Additionally or alternately, the feed for reforming can include 40 wt % or more methane, or 60 wt % or more, or 80 wt % or more, or 95 wt % or more, such as having a feed that is substantially composed of methane (98 wt % or more). In aspects where the reforming corresponds to steam reforming, a molar ratio of steam molecules to carbon atoms in the feed can be 0.3 to 4.0. It is noted that methane has 1 carbon atom per molecule while ethane has 2 carbon atoms per molecule. In aspects where the reforming corresponds to dry reforming, a molar ratio of CO₂ molecules to carbon atoms in the feed can be 0.05 to 3.0.

Within the reforming zone of a reverse flow reactor, the temperature can vary across the zone due to the nature of how heat is added to the reactor and/or due to the kinetics of the reforming reaction. The highest temperature portion of the zone can typically be found near a middle portion of the reactor. This middle portion can be referred to as a mixing zone where combustion is initiated during regeneration. At least a portion of the mixing zone can correspond to part of the reforming zone if a monolith with reforming catalyst extends into the mixing zone. As a result, the location where combustion is started during regeneration can typically be near to the end of the reforming zone within the reactor. Moving from the center of the reactor to the ends of the reactor, the temperature can decrease. As a result, the temperature at the beginning of the reforming zone (at the end of the reactor) can be cooler than the temperature at the end of the reforming zone (in the middle portion of the reactor).

As the reforming reaction occurs, the temperature within the reforming zone can be reduced. The rate of reduction in temperature can be related to the kinetic factors of the amount of available hydrocarbons for reforming and/or the temperature at a given location within the reforming zone. As the reforming feed moves through the reforming zone, the reactants in the feed can be consumed, which can reduce the amount of reforming that occurs at downstream locations. However, the increase in the temperature of the reforming zone as the reactants move across the reforming zone can lead to an increased reaction rate.

At roughly 500° C., the reaction rate for reforming can be sufficiently reduced that little or no additional reforming will occur. As a result, in some aspects as the reforming reaction progresses, the beginning portion of the reforming zone can cool sufficiently to effectively stop the reforming reaction within a portion of the reforming zone. This can move the location within the reactor where reforming begins to a location that is further downstream relative to the beginning of the reforming zone. When a sufficient portion of the reforming zone has a temperature below 500° C., or below 600° C., the reforming step within the reaction cycle can be stopped to allow for regeneration. Alternatively, based on the amount of heat introduced into the reactor during regeneration, the reforming portion of the reaction cycle can be stopped based on an amount of reaction time, so that the amount of heat consumed during reforming (plus heat lost to the environment) is roughly in balance with the amount of heat added during regeneration. After the reforming process is stopped, any remaining synthesis gas product still in the reactor can optionally be recovered prior to starting the regeneration step of the reaction cycle.

The regeneration process can then be initiated. During regeneration, a fuel such as methane, natural gas, or H₂, and oxygen can be introduced into the reactor and combusted. The location where the fuel and oxidant are allowed to mix can be controlled in any convenient manner, such as by introducing the fuel and oxidant via separate channels. By delaying combustion during regeneration until the reactants reach a central portion of the reactor, the non-reforming end of the reactor can be maintained at a cooler temperature. This can also result in a temperature peak in a middle portion of the reactor. The temperature peak can be located within a portion of the reactor that also includes the reforming catalyst. During a regeneration cycle, the temperature within the reforming reactor can be increased sufficiently to allow for the reforming during the reforming portion of the cycle. This can result in a peak temperature within the reactor of 1100° C. or more, or 1200° C. or more, or 1300° C. or more, or potentially a still higher temperature.

The relative length of time and reactant flow rates for the reforming and regeneration portions of the process cycle can be selected to balance the heat provided during regeneration with the heat consumed during reforming. For example, one option can be to select a reforming step that has a similar length to the regeneration step. Based on the flow rate of hydrocarbons, H₂O, and/or CO₂ during the reforming step, an endothermic heat demand for the reforming reaction can be determined. This heat demand can then be used to calculate a flow rate for combustion reactants during the regeneration step. Of course, in other aspects the balance of heat between reforming and regeneration can be determined in other manners, such as by determining desired flow rates for the reactants and then selecting cycle lengths so that the heat provided by regeneration balances with the heat consumed during reforming.

In addition to providing heat, the reactor regeneration step during a reaction cycle can also allow for coke removal from the catalyst within the reforming zone. In various aspects, one or more types of catalyst regeneration can potentially occur during the regeneration step. One type of catalyst regeneration can correspond to removal of coke from the catalyst. During reforming, a portion of the hydrocarbons introduced into the reforming zone can form coke instead of forming CO or CO₂. This coke can potentially block access to the catalytic sites (such as metal sites) of the catalyst. In some aspects, the rate of formation can be increased in portions of the reforming zone that are exposed to higher temperatures, such as portions of the reforming zone that are exposed to temperatures of 800° C. or more, or 900° C. or more, or 1000° C. or more. During a regeneration step, oxygen can be present as the temperature of the reforming zone is increased. At the temperatures achieved during regeneration, at least a portion of the coke generated during reforming can be removed as CO or CO₂.

Due to the variation in temperature across the reactor, several options can be used for characterizing the temperature within the reactor and/or within the reforming zone of the reactor. One option for characterizing the temperature can be based on an average bed or average monolith temperature within the reforming zone. In practical settings, determining a temperature within a reactor requires the presence of a measurement device, such as a thermocouple. Rather than attempting to measure temperatures within the reforming zone, an average (bed or monolith) temperature within the reforming zone can be defined based on an average of the temperature at the beginning of the reforming zone and a temperature at the end of the reforming zone. Another option can be to characterize the peak temperature within the reforming zone after a regeneration step in the reaction cycle. Generally, the peak temperature can occur at or near the end of the reforming zone, and may be dependent on the location where combustion is initiated in the reactor. Still another option can be to characterize the difference in temperature at a given location within the reaction zone at different times within a reaction cycle. For example, a temperature difference can be determined between the temperature at the end of the regeneration step and the temperature at the end of the reforming step. Such a temperature difference can be characterized at the location of peak temperature within the reactor, at the entrance to the reforming zone, at the exit from the reforming zone, or at any other convenient location.

In various aspects, the reaction conditions for reforming hydrocarbons can include one or more of an average reforming zone temperature ranging from 400° C. to 1200° (or more); a peak temperature within the reforming zone of 800° C. to 1500° C.; a temperature difference at the location of peak temperature between the end of a regeneration step and the end of the subsequent reforming step of 25° C. or more, or 50° C. or more, or 100° C. or more, or 200° C. or more, such as up to 800° C. or possibly still higher; a temperature difference at the entrance to the reforming zone between the end of a regeneration step and the end of the subsequent reforming step of 25° C. or more, or 50° C. or more, or 100° C. or more, or 200° C. or more, such as up to 800° C. or possibly still higher; and/or a temperature difference at the exit from the reforming zone between the end of a regeneration step and the end of the subsequent reforming step of 25° C. or more, or 50° C. or more, or 100° C. or more, or 200° C. or more, such as up to 800° C. or possibly still higher. For example, the temperature difference between the end of the regeneration step and the end of the reforming step at the location of peak temperature and/or at the entrance to the reforming zone can be 80° C. to 220° C., or 80° C. to 160° C., or 100° C. to 220° C., or 100° C. to 160° C., or 120° C. to 220° C., or 120° C. to 160° C.

With regard to the average reforming zone temperature, in various aspects the average temperature for the reforming zone can be 500° C. to 1500° C., or 400° C. to 1200° C., or 800° C. to 1200° C., or 400° C. to 900° C., or 600° C. to 1100° C., or 500° C. to 1000° C. Additionally or alternately, with regard to the peak temperature for the reforming zone (likely corresponding to a location in the reforming zone close to the location for combustion of regeneration reactants), the peak temperature can be 800° C. to 1500° C., or 1000° C. to 1400° C., or 1200° C. to 1500° C., or 1200° C. to 1400° C.

Additionally or alternately, the reaction conditions for reforming hydrocarbons can include a pressure of 0 psig to 1500 psig (10.3 MPa), or 0 psig to 1000 psig (6.9 MPa), or 0 psig to 550 psig (3.8 MPa); and a gas hourly space velocity of reforming reactants of 1000 hr⁻¹ to 50,000 hr⁻¹. The space velocity corresponds to the volume of reactants relative to the volume of monolith per unit time. The volume of the monolith is defined as the volume of the monolith as if it was a solid cylinder.

In some aspects, an advantage of operating the reforming reaction at elevated temperature can be the ability to convert substantially all of the methane and/or other hydrocarbons in a reforming feed. For example, for a reforming process where water is present in the reforming reaction environment (i.e., steam reforming or bi-reforming), the reaction conditions can be suitable for conversion of 10 wt % to 100 wt % of the methane in the reforming feed, or 20 wt % to 80 wt %, or 50 wt % to 100 wt %, or 80 wt % to 100 wt %, or 10 wt % to 98 wt %, or 50 wt % to 98 wt %. Additionally or alternately, the reaction conditions can be suitable for conversion of 10 wt % to 100 wt % of the hydrocarbons in the reforming feed, or 20 wt % to 80 wt %, or 50 wt % to 100 wt %, or 80 wt % to 100 wt %, or 10 wt % to 98 wt %, or 50 wt % to 98 wt %

In other aspects, for a reforming process where carbon dioxide is present in the reforming reaction environment (i.e., dry reforming or bi-reforming), the reaction conditions can be suitable for conversion of 10 wt % to 100 wt % of the methane in the reforming feed, or 20 wt % to 80 wt %, or 50 wt % to 100 wt %, or 80 wt % to 100 wt %, or 10 wt % to 98 wt %, or 50 wt % to 98 wt %. Additionally or alternately, the reaction conditions can be suitable for conversion of 10 wt % to 100 wt % of the hydrocarbons in the reforming feed, or 20 wt % to 80 wt %, or 50 wt % to 100 wt %, or 80 wt % to 100 wt %, or 10 wt % to 98 wt %, or 50 wt % to 98 wt %.

In some alternative aspects, the reforming reaction can be performed under dry reforming conditions, where the reforming is performed with CO₂ as a reagent but with a reduced or minimized amount of H₂O in the reaction environment. In such alternative aspects, a goal of the reforming reaction can be to produce a synthesis gas with a H₂ to CO ratio of 1.0 or less. In some aspects, the temperature during reforming can correspond to the temperature ranges described for steam reforming. Optionally, in some aspects a dry reforming reaction can be performed at a lower temperature of between 500° C. to 700° C., or 500° C. to 600° C. In such aspects, the ratio of H₂ to CO can be 0.3 to 1.0, or 0.3 to 0.7, or 0.5 to 1.0. Performing the dry reforming reaction under these conditions can also lead to substantial coke production, which can require removal during regeneration in order to maintain catalytic activity.

### Example of Reverse Flow Reactor Configuration

For endothermic reactions operated at elevated temperatures, such as hydrocarbon reforming, a reverse flow reactor can provide a suitable reaction environment for providing the heat for the endothermic reaction.

In a reverse flow reactor, the heat needed for an endothermic reaction may be provided by creating a high-temperature heat bubble in the middle of the reactor. A two-step process can then be used wherein heat is (a) added to the reactor bed(s) or monolith(s) via in-situ combustion, and then (b) removed from the bed in-situ via an endothermic process, such as reforming, pyrolysis, or steam cracking. This type of configuration can provide the ability to consistently manage and confine the high temperature bubble in a reactor region(s) that can tolerate such conditions long term. A reverse flow reactor system can allow the primary endothermic and regeneration processes to be performed in a substantially continuous manner.

A reverse flow reactor system can include first and second reactors, oriented in a series relationship with each other with respect to a common flow path, and optionally but preferably along a common axis. The common axis may be horizontal, vertical, or otherwise. During a regeneration step, reactants (e.g., fuel and oxygen) are permitted to combine or mix in a reaction zone to combust therein, in-situ, and create a high temperature zone or heat bubble inside a middle portion of the reactor system. The heat bubble can correspond to a temperature that is at least about the initial temperature for the endothermic reaction. Typically, the temperature of the heat bubble can be greater than the initial temperature for the endothermic reaction, as the temperature will decrease as heat is transferred from the heat bubble in a middle portion of the reactor toward the ends of the reactor. In some aspects, the combining can be enhanced by a reactant mixer that mixes the reactants to facilitate substantially complete combustion/reaction at the desired location, with the mixer optionally located between the first and second reactors. The combustion process can take place over a long enough duration that the flow of first and second reactants through the first reactor also serves to displace a substantial portion, (as desired) of the heat produced by the reaction (e.g., the heat bubble), into and at least partially through the second reactor, but preferably not all of the way through the second reactor to avoid waste of heat and overheating the second reactor. The flue gas may be exhausted through the second reactor, but preferably most of the heat is retained within the second reactor. The amount of heat displaced into the second reactor during the regeneration step can also be limited or determined by the desired exposure time or space velocity that the hydrocarbon feed gas will have in the endothermic reaction environment.

After regeneration or heating the second reactor media (such as a phase stable monolith as described herein), in the next/reverse step or cycle, reactants for the endothermic reaction methane (and/or natural gas and/or another hydrocarbon) can be supplied or flowed through the second reactor, from the direction opposite the direction of flow during the heating step. For example, in a reforming process, methane (and/or natural gas and/or another hydrocarbon) can be supplied or flowed through the second reactor. The methane can contact the hot second reactor and mixer media, in the heat bubble region, to transfer the heat to the methane for reaction energy.

For some aspects, the basic two-step asymmetric cycle of a reverse flow regenerative bed reactor system is depicted in FIGS. 2A and 2B of FIG. 2 in terms of a reactor system having two zones/reactors; a first or recuperator/quenching zone (7) and a second or reaction zone (1). Both the reaction zone (1) and the recuperator zone (7) can contain regenerative monoliths and/or other regenerative structures. Regenerative monoliths or other regenerative structures, as used herein, comprise materials that are effective in storing and transferring heat as well as being effective for carrying out a chemical reaction. The regenerative monoliths and/or other structures can correspond to any convenient type of material that is suitable for storing heat, transferring heat, and catalyzing a reaction. Examples of structures can include bedding or packing material, ceramic beads or spheres, ceramic honeycomb materials, ceramic tubes, extruded monoliths, and the like, provided they are competent to maintain integrity, functionality, and withstand long term exposure to temperatures in excess of 1200° C., or in excess of 1400° C., or in excess of 1600° C., which can allow for some operating margin.

To facilitate description of FIG. 2, the reactor is described herein with reference to a reforming reaction. It is understood that other convenient types of endothermic reactions can generally be performed using a reverse flow reactor, such as the reactor shown in FIG. 2.

As shown in FIG. 2A of FIG. 2, at the beginning of the “reaction” step of the cycle, a secondary end 5 of the reaction zone 1 (a.k.a. herein as the second reactor) can be at an elevated temperature as compared to the primary end 3 of the reaction zone 1, and at least a portion (including the first end 9) of the recuperator or quench zone 7 (a.k.a. herein as the first reactor), can be at a lower temperature than the reaction zone 1 to provide a quenching effect for the resulting product. In an aspect where the reactors are used to perform reverse flow reforming, a methane-containing reactant feed (or other hydrocarbon-containing reactant feed) can be introduced via a conduit(s) 15, into a primary end 3 of the reforming or reaction zone 1. In various aspects, the hydrocarbon-containing reactant feed can also contain H₂O, CO₂, or a combination thereof.

The feed stream from inlet(s) 15 can absorb heat from reaction zone 1 and endothermically react to produce the desired synthesis gas product. As this step proceeds, a shift in the temperature profile 2, as indicated by the arrow, can be created based on the heat transfer properties of the system. When the ceramic catalyst monolith/other catalyst structure is designed with adequate heat transfer capability, this profile can have a relatively sharp temperature gradient, which gradient can move across the reaction zone 1 as the reforming step proceeds. In some aspects, a sharper temperature gradient profile can provide for improved control over reaction conditions. In aspects where another type of endothermic reaction is performed, a similar shift in temperature profile can occur, so that a temperature gradient moves across reaction zone 1 as the reaction step proceeds.

The effluent from the reforming reaction, which can include unreacted feed components (hydrocarbons, H₂O, CO₂) as well as synthesis gas components, can exit the reaction zone 1 through a secondary end 5 at an elevated temperature and pass through the recuperator reactor 7, entering through a second end 11, and exiting at a first end 9. The recuperator 7 can initially be at a lower temperature than the reaction zone 1. As the products (and optionally unreacted feed) from the reforming reaction pass through the recuperator zone 7, the gas can be quenched or cooled to a temperature approaching the temperature of the recuperator zone substantially at the first end 9, which in some embodiments can be approximately the same temperature as the regeneration feed introduced via conduit 19 into the recuperator 7 during the second step of the cycle. As the reforming effluent is cooled in the recuperator zone 7, a temperature gradient 4 can be created in the zone's regenerative bed(s) and can move across the recuperator zone 7 during this step. The quenching can heat the recuperator 7, which can be cooled again in the second step to later provide another quenching service and to prevent the size and location of the heat bubble from growing progressively through the quench reactor 7. After quenching, the reaction gas can exit the recuperator at 9 via conduit 17 and can be processed for separation and recovery of the various components.

The second step of the cycle, referred to as the regeneration step, can then begin with reintroduction of the first and second regeneration reactants via conduit(s) 19. The first and second reactants can pass separately through hot recuperator 7 toward the second end 11 of the recuperator 7, where they can be combined for exothermic reaction or combustion in or near a central region 13 of the reactor system.

An example of the regeneration step is illustrated in FIG. 2B of FIG. 2. Regeneration can entail transferring recovered sensible heat from the recuperator zone 7 to the reaction zone 1 to thermally regenerate the reaction beds 1 for the subsequent reaction cycle. Regeneration gas/reactants can enter recuperator zone 7, such as via conduit(s) 19, and flow through the recuperator zone 7 and into the reaction zone 1. In doing so, the temperature gradients 6 and 8 may move across the beds as illustrated by the arrows on the exemplary graphs in FIG. 1(b), similar to but in opposite directions to the graphs of the temperature gradients developed during the reaction cycle in FIG. 2A of FIG. 2. Fuel and oxidant reactants may combust at a region proximate to the interface 13 of the recuperator zone 7 and the reaction zone 1. The heat recovered from the recuperator zone together with the heat of combustion can be transferred to the reaction zone, thermally regenerating the regenerative reaction monoliths and/or beds 1 disposed therein.

In some aspects, several of the conduits within a channel may convey a mixture of first and second reactants, due at least in part to some mixing at the first end (17) of the first reactor. However, the numbers of conduits conveying combustible mixtures of first and second reactants can be sufficiently low such that the majority of the stoichiometrically reactable reactants will not react until after exiting the second end of the first reactor. The axial location of initiation of combustion or exothermic reaction within those conduits conveying a mixture of reactants can be controlled by a combination of temperature, time, and fluid dynamics. Fuel and oxygen usually require a temperature-dependent and mixture-dependent autoignition time to combust. Still though, some reaction may occur within an axial portion of the conduits conveying a mixture of reactants. However, this reaction can be acceptable because the number of channels having such reaction can be sufficiently small that there is only an acceptable or inconsequential level of effect upon the overall heat balance within the reactor. The design details of a particular reactor system can be selected so as to avoid mixing of reactants within the conduits as much as reasonably possible.

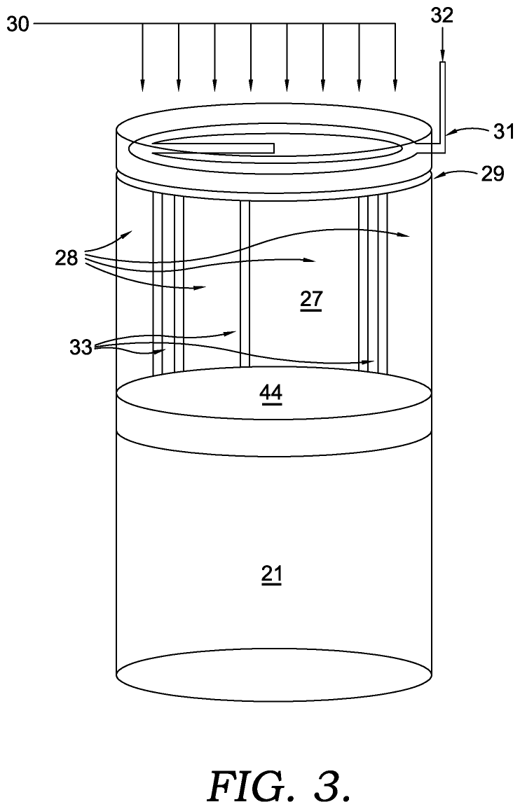

FIG. 3 illustrates another exemplary reactor system that may be suitable in some applications for controlling and deferring the combustion of fuel and oxidant to achieve efficient regeneration heat. FIG. 3 depicts a single reactor system, operating in the regeneration cycle. The reactor system may be considered as comprising two reactor zones. The recuperator 27 can be the zone primarily where quenching takes place and provides substantially isolated flow paths or channels for transferring both of the quenching reaction gases through the reactor media, without incurring combustion until the gasses arrive proximate or within the reactor core 13 in FIG. 2. The reformer 2 can be the reactor where regeneration heating and methane (and/or hydrocarbon) reformation primarily occurs, and may be considered as the second reactor for purposes herein. Although the first and second reactors in the reactor system are identified as separately distinguishable reactors, it is understood that the first and second reactors may be manufactured, provided, or otherwise combined into a common single reactor bed, whereby the reactor system might be described as comprising merely a single reactor that integrates both cycles within the reactor. The terms “first reactor” and “second reactor” can merely refer to the respective zones within the reactor system whereby each of the regeneration, reformation, quenching, etc., steps take place and do not require that separate components be utilized for the two reactors. However, various aspects can comprise a reactor system whereby the recuperator reactor includes conduits and channels as described herein, and the reformer reactor may similarly possess conduits. Additionally or alternately, some aspects may include a reformer reactor bed that is arranged different from and may even include different materials from, the recuperator reactor bed.

As discussed previously, the first reactor or recuperator 27 can include various gas conduits 28 for separately channeling two or more gases following entry into a first end 29 of the recuperator 27 and through the regenerative bed(s) disposed therein. A first gas 30 can enter a first end of a plurality of flow conduits 28. In addition to providing a flow channel, the conduits 28 can also comprise effective flow barriers (e.g., which effectively function such as conduit walls) to prevent cross flow or mixing between the first and second reactants and maintain a majority of the reactants effectively separated from each other until mixing is permitted. As discussed previously, each of the first and second channels can comprise multiple channels or flow paths. The first reactor may also comprise multiple substantially parallel flow segments, each comprising segregated first and second channels.

In some aspects, the recuperator can be comprised of one or more extruded honeycomb monoliths, as described above. Each monolith may provide flow channel(s) (e.g., flow paths) for one of the first or second reactants. Each channel preferably includes a plurality of conduits. Alternatively, a monolith may comprise one or more channels for each reactant with one or more channels or groups of conduits dedicated to flowing one or more streams of a reactant, while the remaining portion of conduits flow one or more streams of the other reactant. It is recognized that at the interface between channels, a number of conduits may convey a mixture of first and second reactant, but this number of conduits is proportionately small.

Alternative embodiments may use reactor media other than monoliths, such as whereby the channel conduits/flow paths may include a more tortuous pathways (e.g. convoluted, complex, winding and/or twisted but not linear or tubular), including but not limited to labyrinthine, variegated flow paths, conduits, tubes, slots, and/or a pore structure having channels through a portion(s) of the reactor and may include barrier portion, such as along an outer surface of a segment or within sub-segments, having substantially no effective permeability to gases, and/or other means suitable for preventing cross flow between the reactant gases and maintaining the first and second reactant gases substantially separated from each other while axially transiting the recuperator 27. Such other types of reactor media can be suitable, so long as at least a portion of such media can be formed by sintering a ceramic catalytic composition as described herein, followed by exposing such media to reducing conditions to activate the catalyst. For such embodiments, the complex flow path may create a lengthened effective flow path, increased surface area, and improved heat transfer. Such design may be preferred for reactor embodiments having a relatively short axial length through the reactor. Axially longer reactor lengths may experience increased pressure drops through the reactor. However for such embodiments, the porous and/or permeable media may include, for example, at least one of a packed bed, an arrangement of tiles, a permeable solid media, a substantially honeycomb-type structure, a fibrous arrangement, and a mesh-type lattice structure.

In some aspects, the reverse flow reactor can include some type of equipment or method to direct a flow stream of one of the reactants into a selected portion of the conduits. In the exemplary embodiment of FIG. 3, a gas distributor 31 can direct a second gas stream 32 to second gas stream channels that are substantially isolated from or not in fluid communication with the first gas channels, here illustrated as channels 33. The result can be that at least a portion of gas stream 33 is kept separate from gas stream 30 during axial transit of the recuperator 27. In some aspects, the regenerative bed(s) and/or monolith(s) of the recuperator zone can comprise channels having a gas or fluid barrier that isolates the first reactant channels from the second reactant channels. Thereby, both of the at least two reactant gases that transit the channel means may fully transit the regenerative bed(s), to quench the regenerative bed, absorb heat into the reactant gases, before combining to react with each other in the combustion zone.

In various aspects, gases (including fluids) 30 and 32 can each comprise a component that reacts with a component in the other reactant 30 and 32, to produce an exothermic reaction when combined. For example, each of the first and second reactant may comprise one of a fuel gas and an oxidant gas that combust or burn when combined with the other of the fuel and oxidant. By keeping the reactants substantially separated, the location of the heat release that occurs due to exothermic reaction can be controlled. In some aspects “substantially separated” can be defined to mean that at least 50 percent, or at least 75 percent, or at least 90 percent of the reactant having the smallest or limiting stoichiometrically reactable amount of reactant, as between the first and second reactant streams, has not become consumed by reaction by the point at which these gases have completed their axial transit of the recuperator 27. In this manner, the majority of the first reactant 30 can be kept isolated from the majority of the second reactant 32, and the majority of the heat release from the reaction of combining reactants 30 and 32 can take place after the reactants begin exiting the recuperator 27. The reactants can be gases, but optionally some reactants may comprise a liquid, mixture, or vapor phase.

The percent reaction for these regeneration streams is meant the percent of reaction that is possible based on the stoichiometry of the overall feed. For example, if gas 30 comprised 100 volumes of air (80 volumes N₂ and 20 Volumes O₂), and gas 32 comprised 10 volumes of hydrogen, then the maximum stoichiometric reaction would be the combustion of 10 volumes of hydrogen (H₂) with 5 volumes of oxygen (O₂) to make 10 volumes of H₂O. In this case, if 10 volumes of hydrogen were actually combusted in the recuperator zone (27), this would represent 100% reaction of the regeneration stream. This is despite the presence of residual un-reacted oxygen, because in this example the un-reacted oxygen was present in amounts above the stoichiometric requirement. Thus, in this example the hydrogen is the stoichiometrically limiting component. Using this definition, less than 50% reaction, or less than 25% reaction, or less than 10% reaction of the regeneration streams can occur during the axial transit of the recuperator (27).

In various aspects, channels 28 and 33 can comprise ceramic (including zirconia), alumina, or other refractory material capable of withstanding temperatures exceeding 1200° C., or 1400° C., or 1600° C. Additionally or alternately, channels 28 and 33 can have a wetted area between 50 ft⁻¹ and 3000 ft⁻¹, or between 100 ft⁻¹ and 2500 ft⁻¹, or between 200 ft⁻¹ and 2000 ft⁻¹.

Referring again briefly to FIG. 2, the reactor system can includes a first reactor 7 containing a first end 9 and a second end 11, and a second reactor 1 containing a primary end 3 and a secondary end 5. The embodiments illustrated in FIGS. 2 and 3 are merely simple illustrations provided for explanatory purposes only and are not intended to represent a comprehensive embodiment. Reference made to an “end” of a reactor merely refers to a distal portion of the reactor with respect to an axial mid-point of the reactor. Thus, to say that a gas enters or exits an “end” of the reactor, such as end 9, means merely that the gas may enter or exit substantially at any of the various points along an axis between the respective end face of the reactor and a mid-point of the reactor, but more preferably closer to the end face than to the mid-point. Thereby, one or both of the first and second reactant gases could enter at the respective end face, while the other is supplied to that respective end of the reactor through slots or ports in the circumferential or perimeter outer surface on the respective end of the reactor.

### Examples—Testing Apparatus

In order to test the long term durability of different types of ceramic monolith materials and/or channel configurations on a reasonable time scale, a testing apparatus was developed to allow for controlled exposure of internal structures from an RFR under temperatures and pressures that could occur in an RFR environment during a cyclic reforming process.

The testing apparatus provides a plurality of features to allow for testing of monolith structures. First, rather than attempting to cycle the temperature within a single furnace, the testing apparatus includes two furnaces. This allows one furnace to be set at a higher temperature and a second furnace to be set at a lower temperature. The furnaces can then be moved up and down relative to the stationary sample to allow for cycling of the temperature of the sample without having to wait for temperature changes for the much larger thermal mass of the furnace. Second, the apparatus allows the sample to be placed under load. In a typical reactor, a plurality or stack of different components will typically be used. The monolith at the bottom of the stack will thus be operating under the load caused by the weight of the other stack elements resting on top of the bottom stack element. Third, the apparatus includes sensors (such as thermocouples) that are placed near, on, or within the samples to allow for temperature monitoring and to determine any changes in the height of the test sample due to thermal expansion/contraction.

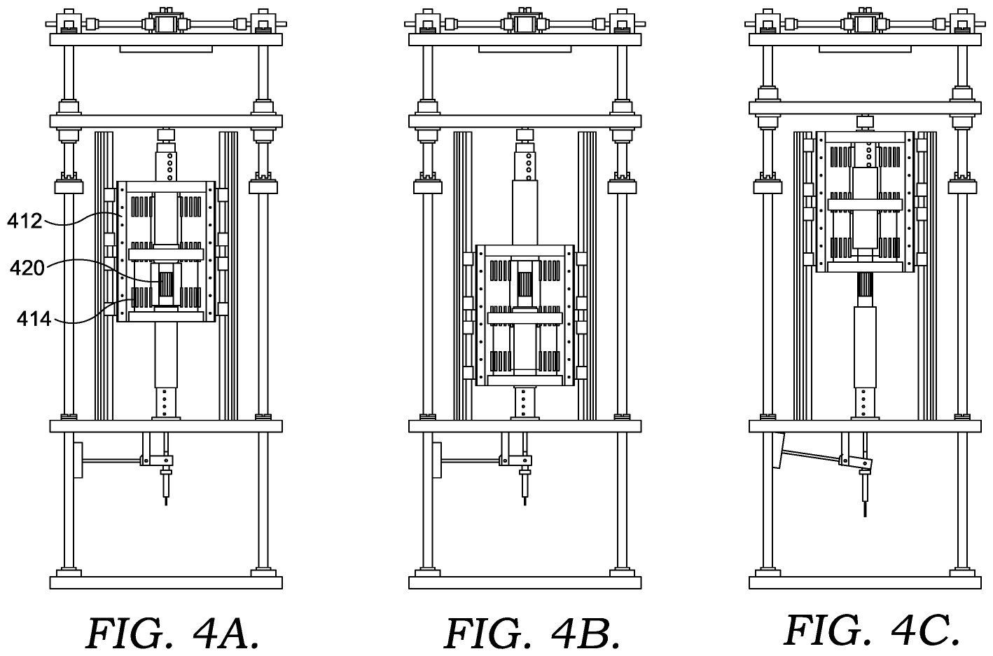

FIG. 4 shows examples of the testing apparatus with the dual furnaces 412 and 414 in three different positions. In position A (FIG. 4A), the testing sample 420 is located with furnace 414. During the testing described in these examples, furnace 414 was used as the “lower” temperature position. It is noted that the lower furnace was operated at 600° C., even though the goal was to cool the monolith to a target temperature of 1000° C. This facilitated more rapid cooling while still maintaining control over the temperature profile in the monolith. In position B (FIG. 4B), testing sample 420 is located within furnace 412, which corresponds to the “high” temperature position. This furnace was operated at 1200° C. during the testing. During testing, temperature cycling was performed by moving the furnaces relative to the sample. After changing the furnace position, the openings for moving the furnace relative to the sample were closed to allow the furnaces to maintain their target temperatures. By moving furnaces relative to the sample, a relatively fast transition in temperature could be achieved for the sample. Position C (FIG. 4C) in FIG. 4 corresponds to a loading position to allow the sample to be loaded into the apparatus.

### Examples—Materials Tested

Four different alumina-based monoliths were tested using the test apparatus. The monoliths were hexagonal. The maximum width (between opposing vertices) for the hexagonal shape was roughly 4 inches (roughly 10 cm). The height was also roughly 4 inches (roughly 10 cm). The monoliths were manufactured by a conventional extrusion and sintering process. The proper amount of all the ingredient oxide powders were mixed with organic binder first. The ingredient oxide powders could be just a single oxide (e.g. Al₂O₃, SiO₂, TiO₂, and ZrO₂) or a mineral powder such as bauxite or talc. For example, bauxite consists mostly of the aluminum minerals gibbsite [Al(OH)₃], boehmite [γ-AlO(OH)] and diaspore [α-AlO(OH)], the aluminum mineral kaolinite [Al₂Si₂O₅(OH)₄], and small amounts of anatase (TiO₂) and ilmenite (FeTiO₃). Talc is a clay mineral and composed of hydrated magnesium silicate with the chemical formula of Mg₃Si₄O₁₀(OH)₂. The mixed “dough” was then aged and kneaded multiple times to induce sufficient plasticity. The dough was then extruded, dried, and heat treated to burn out the organic binder ingredient. A final sintering was performed to consolidate and densify the honeycomb monoliths at 1500˜1700° C. in a controlled heating and cooling ramp for a sufficient time. Optionally, although not used for these test runs, the resulting monoliths of alumina-based ceramics formed in this manner can be further machined to introduce interlocking features to facilitate stacking the monoliths vertically and/or horizontally inside a reactor.

Table 1 shows the composition of the four alumina-based monoliths tested in these examples.

TABLE 1
Monolith Composition

| Materials | A (comparative) | I | C | U |
|---|---|---|---|---|
| Monolith | 500 cpsi, | 300 cpsi, | 400 cpsi, | 400 cpsi, |
| spec | 55% ofa | 40% ofa | 50% ofa | 50% ofa |
| Monolith | Square | Rounded | Rounded | Rounded |
| cell shape | | square | hexagon | hexagon |
| Density | 3.50 | 3.45 | 3.55 | 3.60 |
| (gram/cc) | | | | |
| Chemical | Balanced Al₂O₃ | Balanced Al₂O₃ | Balanced Al₂O₃ | Balanced Al₂O₃ |
| composition | 9.2% SiO₂ | 10.0% SiO₂ | 4.2% SiO₂ | 4.5% SiO₂ |
| (in wt. %) | 1.1% MgO | 1.0% TiO₂ | 0.6% ZrO₂ | 1.0% MgO |
| | | | 0.6% MgO | |
| | | | 0.1% Fe₂O₃ | |
| | | | 0.3% CaO | |
| | | | 0.7% BaO | |
| | | | 0.2% Na₂O | |

As shown in Table 1, the monoliths had open frontal areas between 40% and 55%. The monoliths had cell densities between 300 and 500 cells per square inch. The monoliths had densities between 3.45 gram/cc to 3.60 gram/cc.

In terms of composition, monoliths A and I are comparative. Both monoliths A and I contain more than 9.0 wt % of primary dopant oxides. By contrast, monolith C contains 5.5 wt % of primary dopant oxides and 1.3 wt % of auxiliary and/or contaminant oxides. Monolith U contains 5.5 wt % of primary dopant oxides and no auxiliary and/or contaminant oxides.

In terms of monolith cell shape, monolith A is a comparative example with square channels. Monoliths C and U both have rounded hexagon channel shapes. Although monolith I is comparative with regard to composition, monolith I does use rounded square channels.

### Example 1—Monolith “U”

To test monolith U, the monolith was loaded into the testing apparatus along with a set of three mixer plates composed of Si₃N₄. The mixer plates were scaled to have similar hexagonal shape, and the three mixer plates combined had a total height of roughly 2.5 inches (roughly 6.5 cm).

The monolith “U” and the mixer stack were subjected to total 300 cycles, e.g. 30 cycle period per day for total 10 days, by cycling between 1200° C. and 1000° C. This 200° C. temperature swing is somewhat larger than the expected temperature swing in an RFR during a reforming process of roughly 120° C. to 150° C. This larger temperature differential was selected so that the short time scale of the test could be representative of a longer exposure. An initial load of 372 Newton was placed on the stack for this testing. This is intended to represent that multiple monoliths may be stacked vertically within an RFR. The initial load was selected to represent the weight from having a stack of six honeycomb monoliths in the quench section loaded above the combustor set.

During the cycle, heating time (to increase to the 1200° C. temperature of the hotter furnace) was measured as 7 minutes 42 seconds and cooling time as 3 minutes 42 seconds. Cooling rate is faster since air blows down to provide additional cooling to the unit. When the monolith stack was in the cool furnace position, fresh air was blown inside the lower furnace through a pair of drilled ports connected to a simple air delivery system controlled by a mass flow controller. The introduction of air flow is disabled while the monolith is moving towards and positioned in the hot furnace. This alleviates the heat bleed-over effect when the furnaces are operating in the correct direction, e.g. hot on top and cold on bottom, as the hot air will blow out the upper side of the furnace.

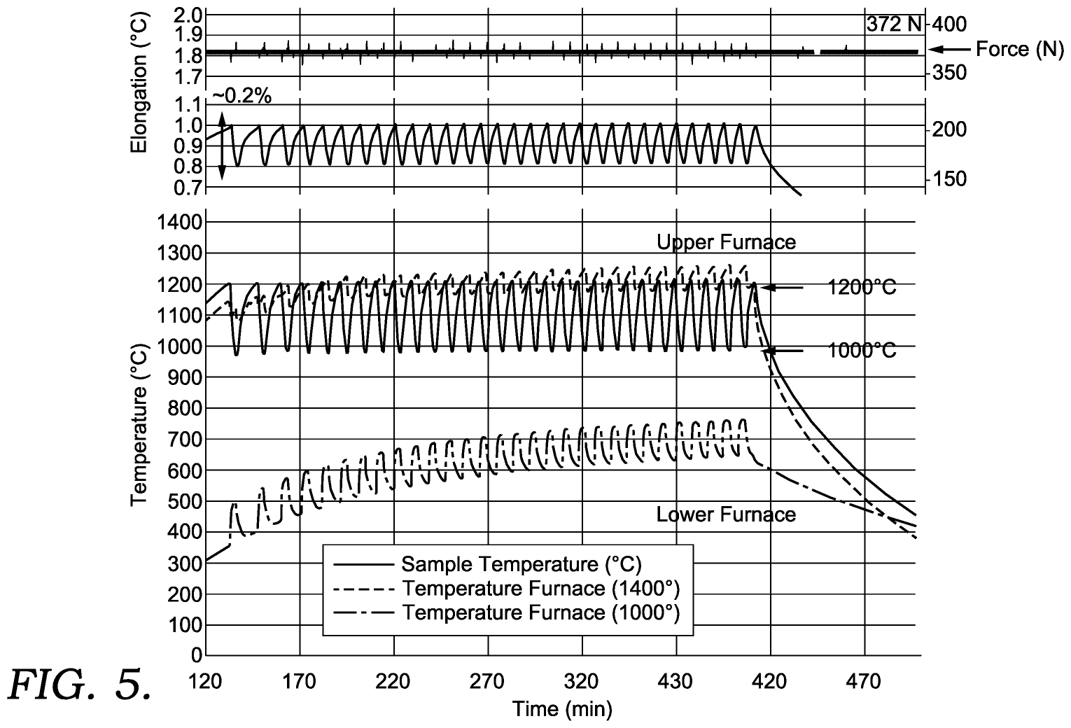

The results of the last 30 cycles on the 10^{th} day can be seen in FIG. 5, which captures the testing variables that would typically recorded during the test. The vertical elongation due to thermal expansion, applied force, and cyclic temperature variations are plotted as a function of time. After 300 thermal cycles between 1200° C. and 1000° C. under load, the monolith “U” revealed no vertical cracks that resulted in a gap in the monolith. However, some hairline cracks were observed. As shown in FIG. 5, the temperature cycles resulted in elongation of the monolith by roughly 0.2%. In spite of the rapid expansion and contraction under applied force, the monolith unexpectedly maintained structural integrity.

It is noted that the temperature and elongation profiles shown in FIG. 5 are similar to the temperature profiles and elongation that were observed for all of the monoliths tested at the end of each of the rapid thermal test procedures. Thus, the difference in performance of the various monoliths tested is believed to be related to the ability of the composition and the structural features to withstand the stress of the high temperature cyclic environment.

### Example 2—Monolith “C”

Monolith “C” was paired with the same set of mixer plates used for Example 1. The monolith “C” and the mixer stack were subjected to total 300 cycles, e.g. 20 cycle period per day for total 15 days, by cycling between 1200° C. and 1000° C. An initial load of 270 Newton was placed on the stack for this testing. Heating time was measured as 9 minutes 35 seconds and cooling time as 3 minutes 50 seconds. After 300 thermal cycles between 1200° C. and 1000° C. under load, the monolith “C” revealed one vertical crack and many hairline cracks. It is believed that the presence of the 1.3 wt % of auxiliary oxides, including 0.1 wt. % Fe₂O₃, 0.3 wt. % CaO, 0.7 wt. % BaO, and 0.2 wt. % Na₂O, reacted with the 4.2 wt. % SiO₂ and formed a glassy grain boundary phase. It is believed that the presence of the glassy grain boundary phase contributed to the formation of the vertical crack through an inter-granular fracture mechanism. However, other than the vertical crack due to the presence of the grain boundary, monolith “C” generally provided unexpectedly good structural stability under the high temperature cyclic conditions. It is believed that the further improved performance of monolith “U” in Example 1 is due to being substantially free of auxiliary oxides, or more generally having less than 1.0 wt % of such auxiliary oxides, so as to avoid formation of glassy grain boundaries that can facilitate crack initiation and/or propagation.

### Comparative Example 3—Monolith “A”

Monolith “A” was paired with the same set of mixer plates used for Example 1. The monolith “A” and the mixer stack was subjected to total 300 cycles, e.g. 30 cycle period per day for total 10 days, by cycling between 1200° C. and 1000° C. An initial load of 379 Newton was placed on the stack for this testing. Heating time was measured as 8 minutes 57 seconds and cooling time as 3 minutes 50 seconds. After 300 thermal cycles between 1200° C. and 1000° C. under load, the monolith “A” revealed many vertical cracks, indicating a substantial loss in structural integrity. It is believed that the presence of more than 9.0 wt % of primary dopant oxides (9.2 wt. % SiO₂, 1.1 wt. % wt. % MgO) resulted in formation of brittle grain boundary phases. The brittle phases combined with the corner vertex features of the square channels to allow a plurality of cracks to propagate across the entire monolith, resulting in breaking of the monolith into four separate pieces by the end of the testing cycle.

### Comparative Example 4—Monolith “I” Cycling Between 1300° C. and 1000° C.

To test monolith I, two short monoliths (1.8 inches in height) were loaded into the testing apparatus along with a set of four mixer plates composed of Si₃N₄ which was placed in the middle. This was to mimic a reactor configuration where quench monoliths are stacked above the set of mixer plates while catalyst washcoated reforming monoliths are stacked below the set of mixer plates. The mixer plates were scaled to have similar hexagonal shape, and the four mixer plates combined had a total height of roughly 2.2 inches (roughly 5.6 cm).

A sandwiched stack of two monoliths “I” above and below the mixer stack in the middle was subjected to total 200 cycles, e.g. 20 cycle period per day for total 10 days, by cycling between 1300° C. and 1000° C. This 300° C. temperature swing is somewhat larger than the expected temperature swing in an RFR during a reforming process of roughly 120° C. to 150° C. This larger temperature differential was selected so that the short time scale of the test could be representative of a longer exposure. An initial load of 255 Newton was placed on the stack for this testing. The initial load value was selected to represent the weight from having a stack of six honeycomb monoliths in the quench section loaded above the combustor set. Also, the load value was adjusted to generate the same pressure after accounting for the actual contact areas between the monoliths and the mixer stack. This is intended to represent that multiple monoliths may be stacked vertically within an RFR.

During the cycle, heating time (to increase to the 1300° C. temperature of the hotter furnace) was measured as 21 minutes 19 seconds and cooling time as 11 minutes 59 seconds. Cooling rate is faster since air blows down to provide additional cooling to the unit. When the monolith stack was in the cool furnace position, fresh air was blown inside the lower furnace through a pair of drilled ports connected to a simple air delivery system controlled by a mass flow controller. The introduction of air flow is disabled while the monolith is moving towards and positioned in the hot furnace. This alleviates the heat bleed-over effect when the furnaces are operating in the correct direction, e.g. hot on top and cold on bottom, as the hot air will blow out the upper side of the furnace.

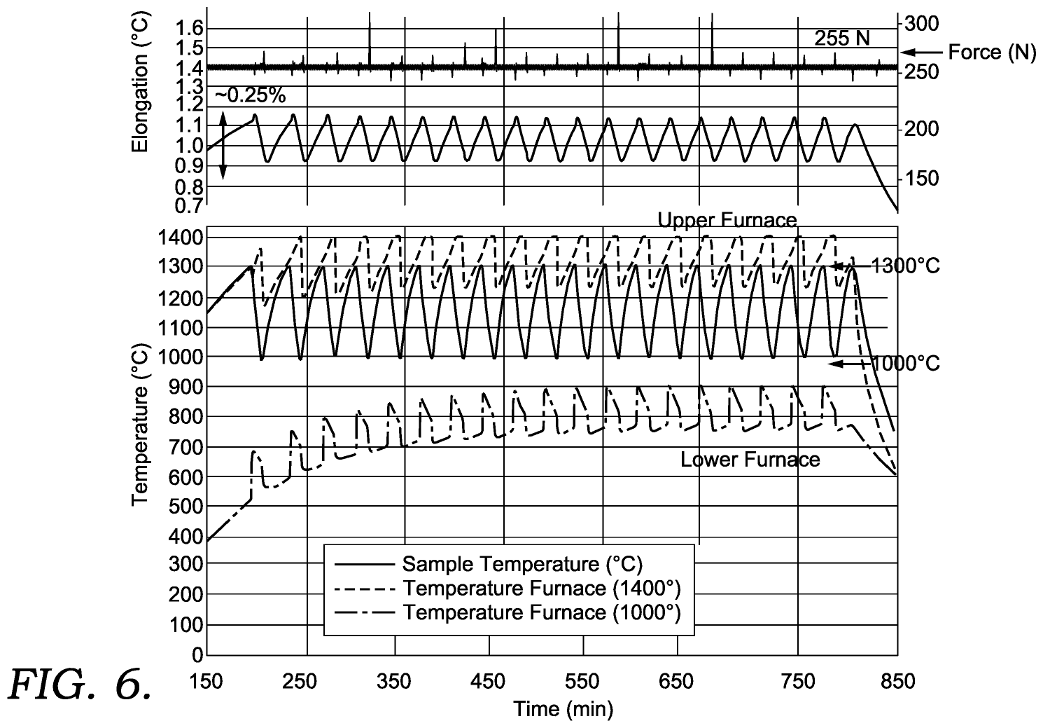

The results of the last 20 cycles on the 10^{th} day can be seen in FIG. 6 which captures the testing variables that would typically recorded during the test. The vertical elongation due to thermal expansion, applied force, and cyclic temperature variations are plotted as a function of time. After 200 thermal cycles between 1300° C. and 1000° C. under load, the monolith “I” revealed many vertical and horizontal cracks that turned the monolith into multiple fractured pieces. As shown in FIG. 6, the temperature cycles resulted in elongation of the monolith by roughly 0.25%. Due to rapid expansion and contraction under applied force and severe thermal shock driven from cycling between 1300° C. and 1000° C., the monolith lost structural integrity completely.

It is noted that the temperature and elongation profiles shown in FIG. 6 are similar to the temperature profiles and elongation that were observed for all of the monoliths tested at the end of each of the rapid thermal test procedures under the same testing conditions. Thus, the difference in performance of the various monoliths tested is believed to be related to the ability of the composition and the structural features to withstand the stress of the high temperature cyclic environment.

It is believed that the presence of more than 9.0 wt % of primary dopant oxides (10.0 wt % SiO₂, 1.0 wt % TiO₂) resulted in formation of brittle grain boundary phases. The brittle phases are believed to allow a plurality of cracks to initiate and propagate across the entire monolith, resulting in breaking of the monoliths into multiple separate pieces by the end of the testing cycle.

### Example 5—Monolith “U_{sq}” Cycling Between 1300° C. and 1000° C.

In order to demonstrate the benefit of the structural features to withstand the stress of the high temperature cyclic environment, monolith “U_{sq}” was made with square channels. Thus, monolith “U_{sq}” had a composition similar to monolith “U”, but with square channels instead of the rounded hexagons of monolith “U”. Similar to Example 4, two short monoliths (1.8 inches in height) were loaded into the testing apparatus along with a set of four mixer plates composed of Si₃N₄ which is placed in the middle.

A sandwiched stack of two monoliths “U_{sq}” above and below the mixer stack in the middle was subjected to total 200 cycles, e.g. 20 cycle period per day for total 10 days, by cycling between 1300° C. and 1000° C. This 300° C. temperature swing is somewhat larger than the expected temperature swing in an RFR during a reforming process of roughly 120° C. to 150° C. This larger temperature differential was selected so that the short time scale of the test could be representative of a longer exposure. An initial load of 384 Newton was placed on the stack for this testing. The initial load value was selected to represent the weight from having a stack of six honeycomb monoliths in the quench section loaded above the combustor set. Also, the load value was adjusted to generate the same pressure after accounting for the actual contact areas between the monoliths and the mixer stack. This is intended to represent that multiple monoliths may be stacked vertically within an RFR.

During the cycle, heating time (to increase to the 1300° C. temperature of the hotter furnace) was measured as 22 minutes 30 seconds and cooling time as 11 minutes 18 seconds. Cooling rate is faster since air blows down to provide additional cooling to the unit. When the monolith stack was in the cool furnace position, fresh air was blown inside the lower furnace through a pair of drilled ports connected to a simple air delivery system controlled by a mass flow controller. The introduction of air flow is disabled while the monolith is moving towards and positioned in the hot furnace. This alleviates the heat bleed-over effect when the furnaces are operating in the correct direction, e.g. hot on top and cold on bottom, as the hot air will blow out the upper side of the furnace.

The results of the last 20 cycles on the 10^{th} day were similar to FIG. 6, but the temperature cycles resulted in elongation of the monolith by roughly 0.23%. Regardless of rapid expansion and contraction under applied force and severe thermal shock driven from cycling between 1300° C. and 1000° C., the monolith unexpectedly substantially retained structural integrity, although with less favorable performance than monolith “U”. The quench monolith placed above the mixer stack revealed no vertical cracks, but the reforming monolith placed below the mixer stack showed two vertical cracks as well as some hairline cracks.

It is believed that the presence of more than 3.0 wt. % and less than 9.0 wt. % of primary dopant oxides (4.5 wt. % SiO₂, 1.0 wt. % wt. % MgO) in the monolith “U” is primarily responsible for good performance. It is believed that the channels with square corners in monolith “U_{sq}” acted as stress concentration points and allowed crack initiation and propagation. This crack initiation and propagation was substantially avoided for monolith “U” with the rounded hexagon channels.

Thus, by combining the preferred composition of the monoliths with the structural features of the rounded channel shapes, the monoliths of this invention are able to withstand the stress of the high temperature cyclic environment.

### Examples 6 and 7—Additional Comparative Monoliths

A number of additional comparative monoliths were formed and sintered. One general feature was found for monoliths that includes more than 1.5 wt % of secondary oxides. It was discovered that monoliths that had 3.0 wt % to 9.0 wt % of primary oxides, but that also included more than 1.5 wt % of secondary oxides, resulted in compositions where detrimental glassy phases formed at grain boundaries. Based on the formation of these detrimental glassy phases, further testing was not performed on these samples with more than 1.5 wt % of secondary oxides.

Additional comparative monoliths were also formed with lower contents of SiO₂ and/or lower contents of primary dopant oxides. These compositions are shown in Table 2 as as Comparative Monolith 6 and Comparative Monolith 7. Versions of both Comparative Monolith 6 and Comparative Monolith 7 were formed using two different sintering temperatures, which resulted in a different densities. This accounts for the two densities provided in Table 2 for each of Comparative Monolith 6 and Comparative Monolith 7. In Table 2, the “others” column corresponds to other primary dopant oxides.

TABLE 2
Composition for Comparative Monoliths 6 and 7

| | Al₂O₃ | SiO₂ | CaO | Na₂O | BaO | Others | Density |
|---|---|---|---|---|---|---|---|
| Comparative | 96.6 | 1.1 | 0.07 | 0.09 | 0.01 | 2.13 | 3.65/3.55 |
| Monolith 6 | | | | | | | |
| Comparative | 98.3 | 0.5 | 0.09 | 0.11 | 0.01 | 0.99 | 3.63/3.52 |
| Monolith 7 | | | | | | | |

As shown in Table 2, the Comparative Monolith 6 samples had a total primary dopant concentration between 3.0-9.0 wt %, but the SiO₂ content was less than 3.0 wt %. The Comparative Monolith 7 samples had both a low primary dopant concentration (less than 2.0 wt %) and a low SiO₂ content (0.5 wt %).

The Comparative Monolith 6 higher density sample was exposed to heating and cooling cycles to test the durability of the sample. During the testing, the comparative monolith was paired with the same set of mixer plates used for Example 1 above. The monolith and the mixer stack were subjected to a total of 300 cycles, e.g. 30 cycle period per day for total 10 days, by cycling between 1200° C. and 1000° C. An initial load of 222 Newton was placed on the stack for this testing. Heating time was measured as 9 minutes, 3 seconds and cooling time as 4 minutes, 9 seconds.

For the Comparative Monolith 6 sample, after 30 thermal cycles between 1200° C. and 1000° C. under load, the monolith revealed one vertical crack and fractured into two separate pieces. Thus, failure occurred after only 30 heating/cooling cycles. It is believed that the reduced amount of the auxiliary oxides (e.g., 0.09 wt. % Na₂O, 0.01 wt. % BaO) suppressed formation of a glassy grain boundary phase in the monoliths corresponding to Comparative Monolith 6. However, because the composition of Comparative Monolith 6 only included a 1.1 wt. % SiO₂ content, which resulted in premature failure. Without being bound by any particular theory, it is believed that both 3.0-9.0 wt. % of total primary dopants and at least 3.0 wt. % of SiO₂ content in the monolith is needed to provide superior ceramic durability. For example, the added silica provide by having at least 3.0 wt % SiO₂ is believed to react with alumina grains at proper sintering temperatures, resulting in formation of a desired mullite phase during cooling. The resulting mullite grains often form as an acicular shape, which interlocks neighboring alumina grains and enhances thermo-mechanical properties.

The Comparative Monolith 7 higher density sample was also exposed to heating and cooling cycles to test the durability of the sample. During the testing, the comparative monolith was paired with the same set of mixer plates used for Example 1 above. The monolith and the mixer stack were subjected to a total of 300 cycles, e.g. 30 cycle period per day for total 10 days, by cycling between 1200° C. and 1000° C. An initial load of 224 Newton was placed on the stack for this testing. Heating time was measured as 12 minutes, 52 seconds and cooling time as 3 minutes, 50 seconds.

For the Comparative Monolith 7 sample, after 30 thermal cycles between 1200° C. and 1000° C. under load, the monolith revealed one vertical crack and fractured into two separate pieces. Thus, the Comparative Monolith 7 sample failed in a similar manner to Comparative Monolith 6.

By contrast, the monolith “U” described above revealed no cracks after 300 cycles (10 days) while the monolith “C” described above revealed a similar single crack only after 300 cycles. This shows the substantial and unexpected improvement in durability for monolith compositions having sufficient primary dopant oxides (including sufficient SiO₂) while also having a reduced or minimized content of secondary oxides.

### Additional Embodiments

Embodiment 1. A ceramic monolith, comprising: 89.5 wt % to 97.0 wt % α-alumina, 3.0 wt % to 9.0 wt % of dopant oxides comprising SiO₂, MgO, CaO, TiO₂, ZrO₂, HfO₂, Y₂O₃, or a combination thereof, and 1.5 wt % or less of auxiliary oxides comprising Na₂O, SrO, BaO, K₂O, and Fe₂O₃, the monolith comprising at least 3.0 wt % of SiO₂, the monolith comprising an open frontal area of 30% to 70% and a channel density of 50 cells per square inch to 900 cells per square inch, the monolith comprising channels having a cross-section comprising a) rounded vertices, the rounded vertices comprising a normalized radius of curvature of 0.15 to 0.65, b) a substantially circular cross-section, or c) a combination of a) and b).

Embodiment 2. The monolith of Embodiment 1, wherein the channels have a cross-section comprising rounded rectangles, rounded squares, rounded hexagons, or a combination thereof, the normalized radius of curvature being normalized based on a distance between opposing sides of the rounded rectangles, rounded squares, rounded hexagons, or a combination thereof.

Embodiment 3. The monolith of Embodiment 1, wherein the channels have a substantially circular cross-section, or wherein the channels have a cross-section comprising rounded triangles.

Embodiment 4. The monolith of any of the above embodiments, wherein the monolith comprises 1.0 wt % or less of the auxiliary oxides, the monolith optionally comprising 0.1 wt % to 1.0 wt % of the auxiliary oxides.

Embodiment 5. The monolith of any of the above embodiments, wherein the monolith comprises 0.1 wt % or less of the auxiliary oxides.

Embodiment 6. The monolith of any of the above embodiments, wherein the weight of dopant oxides is greater than the weight of SiO₂.

Embodiment 7. The monolith of any of the above embodiments, wherein the monolith comprises a density of 3.40 grams/cc or more.

Embodiment 8. The monolith of any of the above embodiments, wherein the monolith comprises a cell density of 300 cells per square inch to 600 cells per square inch.

Embodiment 9. The monolith of any of the above embodiments, wherein the monolith further comprises a catalyst system supported on the monolith.

Embodiment 10. The monolith of Embodiment 9, wherein the catalyst system comprises a reforming catalyst.

Embodiment 11. A method for reforming a hydrocarbon-containing stream to produce hydrogen, comprising: exposing a ceramic monolith to a plurality of heating steps and cooling steps within a reactor, the ceramic monolith comprising reforming catalyst supported on one or more surfaces of the monolith, the cooling steps comprising exposing the reforming catalyst to a hydrocarbon-containing stream at a temperature of 500° C. to 1400° C. to produce hydrogen, the heating steps comprising heating the one or more surfaces to a temperature greater than a temperature of the one or more surfaces at the end of a prior cooling step, wherein the ceramic monolith comprises a monolith according to any of Embodiments 1 to 9.

Embodiment 12. The method of Embodiment 11, wherein the cooling steps comprising exposing the reforming catalyst to the hydrocarbon-containing stream at a temperature of 800° C. to 1400° C.

Embodiment 13. The method of Embodiment 11 or 12, wherein the reforming catalyst comprises a reforming catalyst system.

Embodiment 14. The method of any of Embodiments 11 to 13, wherein the reforming catalyst comprises NiAl₂O₄, NiO, or a combination of thereof.

Embodiment 15. Use of the ceramic monolith of any of Embodiments 1 to 10.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A ceramic monolith, comprising:
89.5 wt % to 97.0 wt % α-alumina,
3.0 wt % to 9.0 wt % of dopant oxides comprising SiO₂, MgO, CaO, TiO₂, ZrO₂, HfO₂, Y₂O₃, or a combination thereof, and
1.5 wt % or less of auxiliary oxides comprising Na₂O, SrO, BaO, K₂O, and Fe₂O₃,
the monolith comprising at least 3.0 wt % of SiO₂,
the monolith comprising an open frontal area of 30% to 70% and a channel density of 50 cells per square inch to 900 cells per square inch, the monolith comprising channels having a cross-section comprising a) rounded vertices, the rounded vertices comprising a normalized radius of curvature of 0.15 to 0.65, b) a substantially circular cross-section, or c) a combination of a) and b).

2. The monolith of claim 1, wherein the channels have a cross-section comprising rounded rectangles, rounded squares, rounded hexagons, or a combination thereof.

3. The monolith of claim 2, wherein the normalized radius of curvature is normalized based on a distance between opposing sides of the rounded rectangles, rounded squares, rounded hexagons, or a combination thereof.

4. The monolith of claim 1, wherein the channels have a substantially circular cross-section.

5. The monolith of claim 1, wherein the channels have a cross-section comprising rounded triangles.

6. The monolith of claim 1, wherein the monolith comprises 1.0 wt % or less of the auxiliary oxides.

7. The monolith of claim 1, wherein the monolith comprises 0.1 wt % or less of the auxiliary oxides.

8. The monolith of claim 1, wherein the weight of dopant oxides is greater than the weight of SiO₂.

9. The monolith of claim 1, wherein the monolith comprises a density of 3.40 grams/cc or more.

10. The monolith of claim 1, wherein the monolith comprises a cell density of 300 cells per square inch to 600 cells per square inch.

11. The monolith of claim 1, wherein the monolith further comprises a catalyst system supported on the monolith.

12. A method for reforming a hydrocarbon-containing stream to produce hydrogen, comprising:
exposing a ceramic monolith to a plurality of heating steps and cooling steps within a reactor, the ceramic monolith comprising reforming catalyst supported on one or more surfaces of the monolith, the cooling steps comprising exposing the reforming catalyst to a hydrocarbon-containing stream at a temperature of 500° C. to 1400° C. to produce hydrogen, the heating steps comprising heating the one or more surfaces to a temperature greater than a temperature of the one or more surfaces at the end of a prior cooling step,
wherein the ceramic monolith comprises:
89.5 wt % to 97.0 wt % α-alumina,
3.0 wt % to 9.0 wt % of dopant oxides comprising SiO₂, MgO, CaO, TiO₂, ZrO₂, HfO₂, Y₂O₃, or a combination thereof, and
1.5 wt % or less of auxiliary oxides comprising Na₂O, SrO, BaO, K₂O, and Fe₂O₃,
the monolith comprising at least 3.0 wt % of SiO₂,
the monolith comprising an open frontal area of 30% to 70% and a channel density of 50 cells per square inch to 900 cells per square inch, the monolith comprising channels having a cross-section comprising a) rounded vertices, the rounded vertices comprising a normalized radius of curvature of 0.15 to 0.65, b) a substantially circular cross-section, or c) a combination of a) and b).

13. The method of claim 12, wherein the cooling steps comprising exposing the reforming catalyst to the hydrocarbon-containing stream at a temperature of 800° C. to 1400° C.

14. The method of claim 12, wherein the reforming catalyst comprises a reforming catalyst system.

15. The method of claim 12, wherein the reforming catalyst comprises NiAl₂O₄, NiO, or a combination of thereof.

16. The method of claim 12, wherein the channels have a cross-section comprising rounded rectangles, rounded squares, rounded hexagons, or a combination thereof.

17. The method of claim 16, wherein the normalized radius of curvature is normalized based on a distance between opposing sides of the rounded rectangles, rounded squares, rounded hexagons, or a combination thereof.

18. The method of claim 12, wherein the monolith comprises 1.0 wt % or less of the auxiliary oxides.

19. The method of claim 12, wherein the monolith comprises 0.1 wt % or less of the auxiliary oxides.

20. The method of claim 12, wherein the weight of dopant oxides is greater than the weight of SiO₂.
